(19) United States
(12) Patent Application Publication
(10) Pub. No.: US 2024/0336503 A1
(43) Pub. Date: Oct. 10, 2024

(54) Production Efficiency Optimization For Bipolar Electrodialysis Device

(71) Applicant: Ebb Carbon, Inc., San Carlos, CA (US)

(72) Inventors: Jeremy Loretz, Palo Alto, CA (US); Anthony Canalungo, San Carlos, CA (US); Matthew Eisaman, Port Jefferson, NY (US); Todd Pelman, Moss Beach, CA (US)

(21) Appl. No.: 18/131,839

(22) Filed: Apr. 6, 2023

(51) Int. Cl. C02F 1/469

(52) U.S. Cl. CPC C02F 1/4693; C02F 2103/08; C02F 2201/4614; C02F 2209/006; C02F 2209/07; C02F 2209/40

(57) ABSTRACT

A production efficiency optimization method systematically modifies selected control parameters that determine the operating state of a bipolar electrodialysis device (BPED) while performing an electrochemical process. A first production efficiency level is measured when the BPED is in a first operating state, then a selected control parameter (e.g., ion exchange stack current level) is incrementally modified (increased or decreased) to switch the BPED into a second operating state, and then a second production efficiency level is measured. A comparison between the first and second production efficiency levels is utilized to determine the direction (increase or decrease) of a subsequent incremental modification of the selected control parameter such that BPED production efficiency is systematically improved. When a maximum production efficiency level is detected using modifications to the first control parameter, the systematic modification process is repeated using a second control parameter (e.g., salt solution flow rate or acid/base concentration).

### FIELD OF THE INVENTION

The systems and methods described herein relate to bipolar electrodialysis devices utilized, for example, in ocean alkalinity enhancement systems to both reduce atmospheric carbon dioxide (CO₂) and mitigate ocean acidification.

### BACKGROUND OF THE INVENTION

As humans burn more and more fossil fuels, the resulting increased carbon dioxide (CO₂) concentration in Earth's atmosphere causes both climate change and ocean acidification. The increased atmospheric concentrations of CO₂ and other greenhouse gasses (e.g., methane) produces climate change by trapping heat close to earth's surface, thereby increasing both air and sea temperatures. Because earth's oceans absorb about 25% of atmospheric CO₂, and because the absorbed CO₂ dissolves to form carbonic acid that remains trapped in the seawater, the increased atmospheric CO₂ concentration caused by burning fossil fuels also produces ocean acidification by way of increasing the amount of CO₂ gas dissolved in the ocean.

Both climate change and ocean acidification pose significant threats to humans. Climate change in the form of increased global average temperatures can produce several dangerous effects such as the loss of polar ice and corresponding increased sea levels, disease, wildfires and stronger storms and hurricanes. Ocean acidification changes the ocean chemistry that most marine organisms rely on. One concern with ocean acidification is that the decreased seawater pH can lead to the decreased survival of shellfish and other aquatic life having calcium carbonate shells, as well as some other physiological challenges for marine organisms.

To avoid dangerous climate change, the international Paris Agreement aims to limit the increase in global average temperature to no more than 1.5° C. to 2° C. above the temperatures of the pre-industrial era. Global average temperatures have already increased by between 0.8° C. and 1.2° C. The Intergovernmental Panel on Climate Change (IPCC) estimates that a ‘carbon budget’ of about 500 GtCO₂ (billion tons of carbon dioxide), which corresponds to about ten years at current emission rates, provides a 66% chance of limiting climate change to 1.5° C.

In addition to cutting CO₂ emissions by curtailing the use of fossil fuels, climate models predict that a significant deployment of Negative Emissions Technologies (NETs) will be needed to avoid catastrophic ocean acidification and global warming beyond 1.5° C. (see “Biophysical and economic limits to negative CO₂ emissions”, Smith P. et al., Nat. Clim. Chang. 2016; 6:42-50). Current atmospheric CO₂ and other greenhouse gas concentrations are already at dangerous levels, so even a drastic reduction in greenhouse gas emissions would merely curtail further increases, not reduce atmospheric greenhouse gas concentrations to safe levels. Moreover, the reduction or elimination of certain greenhouse gas sources (e.g., emissions from long distance airliners) would be extremely disruptive and/or expensive and are therefore unlikely to occur soon.

Therefore, there is a need to supplement emission reductions with the deployment of NETs, which are systems/processes that serve to reduce existing atmospheric greenhouse gas concentrations by, for example, capturing/removing CO₂ from the air and sequestering it for at least 1,000 years. The need for NETs may be explained using a bathtub analogy in which atmospheric CO₂ is represented by water contained in a bathtub, ongoing CO₂ emissions are represented by water flowing into the tub, and NETs are represented by processes that control water outflow through the tub's drain. In this analogy, reduced CO₂ emission rates are represented by partially turning off the water inflow tap—the slower inflow rate provides more time before the tub fills, but the tub's water level will continue to rise and eventually overflow. Using this analogy, although reducing CO₂ emissions may slow the increase of greenhouse gas in the atmosphere, critical concentration levels will eventually be reached unless NETs are implemented that can offset the reduced CO₂ emission level (i.e., remove atmospheric CO₂ at the same rate it is being emitted). Moreover, because greenhouse gas concentrations are already at dangerous levels (i.e., the tub is already dangerously full), there is an urgent need for NETs that are capable of significantly reducing atmospheric CO₂ faster than it is being emitted to achieve safe atmospheric concentration levels (i.e., outflow from the tub's drain must be greater than the reduced inflow from the tap to reduce the tub's water to a safe level).

NETs can be broadly characterized as Direct Air Capture (DAC) approaches and Ocean Capture approaches. DAC approaches utilize natural (e.g., reforestation) and technology-based methods to extract CO₂ directly from the atmosphere. Ocean capture approaches utilize various natural and/or technological processes to remove CO₂ from the atmosphere and store it in the ocean as bicarbonate, a form of carbon storage that is stable for over 10,000 years.

Electrochemical ocean alkalinity enhancement (OAE) represents an especially promising ocean capture approach that both reduces atmospheric CO₂ and mitigates ocean acidification by generating an ocean alkalinity product (i.e., an aqueous alkaline solution containing a fully dissolved base substance) and supplying the ocean alkalinity product to ocean seawater at a designated outfall location. OAE systems typically generate the required base substance using a bipolar electrodialysis device (BPED), which generally includes an ion exchange (IE) stack that utilizes an electrochemical process to convert salt supplied in a feedstock solution into the base substance and an acid substance. The base substance is then supplied to the ocean in the ocean alkalinity product. As the base substance diffuses (disperses) into the surrounding seawater it serves to directly reverse ocean acidification (i.e., by utilizing the base substance in the ocean alkalinity product to increases the ocean seawater's alkalinity), and indirectly reduces atmospheric CO₂ (i.e., increasing the ocean seawater's alkalinity increases the ocean's ability to absorb/capture atmospheric CO₂). Moreover, because the generated base substance is fully dissolved in the ocean alkalinity product, the electrochemical OAE approach avoids problems associated with other OAE approaches (e.g., dissolution kinetics issues that are associated with conventional mineral OAE approaches).

Although electrochemical OAE approaches show great potential in mankind's efforts to combat global warming and ocean acidification, their widespread acceptance as a suitable NET may be predicated on the development of automated operating systems that minimize cost per unit of captured/removed atmospheric CO₂ (LCOC). For economic reasons related to carbon offsets and trading, NETs having relatively low LCOC ratings are typically favored over NETs exhibiting relatively high LCOCs. When calculating a NET's LCOC rating, many factors are taken into consideration, including capital costs (e.g., construction and installation expenses), ongoing operating costs (e.g., land, water, operation and maintenance, and electrical power expenses), and the verifiability/measurability of carbon capture. In the case of OAE systems, the amount of atmospheric carbon removed from the atmosphere over an ocean depends on the amount of base substance supplied to the ocean (i.e., by way of the ocean alkalinity product), whereby the LCOC of an OAE system is predominantly determined by its levelized cost of producing each unit of base substance. In terms of the capital cost components of LCOC, OAE systems have an advantage over many NETs in that OAE systems are relatively inexpensive to construct and install, have a relatively small footprint and can be controlled using automated operating systems. In terms of the operating cost components of LCOC, the ongoing cost of externally supplied electricity, which is mainly consumed by the BPED during the base-generating process, currently represents the most significant OAE system operating expense (i.e., roughly equal to a sum of land, water, operating and maintenance, and all other operating costs, based on estimated 2027 Megaton production scale values from a current Techno-Economic Analysis). Note that the verification and measurability of carbon capture remain an issue (i.e., because it is difficult to measure the amount of carbon captured after supplying the ocean alkalinity product to the ocean). Because the effectiveness of OAE systems as a NET is strongly dependent on minimizing LCOC, because the LCOC of an OAE system is mostly determined by its levelized cost of producing the base substance provided in the ocean alkalinity product, and because the cost of externally supplied electricity is the most significant expense associated with the production of base substance, there is a strong motivation to optimize OAE system operations in a way that maximizes base production efficiency (i.e., the amount of base substance produced per unit of power consumption).

Unfortunately, controlling OAE system operations in a way that reliably maximizes base production efficiency (i.e., minimizes LCOC) is problematic due to Faradaic efficiency drift (i.e., a continuous gradual change in the IE stack's Faradaic efficiency). As mentioned above, base production involves an electrochemical salt conversion process performed in the BPED's IE stack. Faradaic efficiency describes the efficiency with which charge is transferred within the IE stack at a given point in time (i.e., during the electrochemical salt conversion process) and determines the highest achievable base production efficiency at any given applied stack current level (i.e., the amount of current passed through the IE stack during the electrochemical process). An IE stack's Faradaic efficiency undergoes a continuous gradual change (drift) that is caused by changes in various independent operating condition variables associated with the electrochemical process including process input conditions under which an OAE system must operate (e.g., increasing/decreasing seawater salinity and/or pH, changing ambient temperature, etc.) and wear-and-tear that effect system dynamics (e.g., increasing stack resistance due to scale build-up, changing fluid properties, pretreatment efficacy, etc.). Faradaic efficiency drift makes it difficult to minimize an OAE system's LCOC because whenever BPED operations were set such that base production efficiency was optimized, the subsequent continuous gradual change in the independent operating condition variables associated with Faradaic efficiency drift will eventually move BPED operations away from the optimal base production efficiency (i.e., result in sub-optimal base production efficiency, thereby increasing LCOC).

It may be possible to address the Faradaic efficiency drift problem using a predictive knowledge approach, but such a solution would be difficult (maybe impossible) to implement in the context of an OAE system. Predictive knowledge (predictive analytics) is a statistics-based data analysis approach that uses historical, present and simulated future data to provide real-time solutions. In the context of an OAE system, a predictive knowledge solution would involve collecting data for each of the independent operating condition variables that collectively cause Faradaic efficiency drift and utilizing historical data to identify and apply BPED operational settings that would optimize base production efficiency in real time. Although predictive-knowledge-type dynamic BPED operating methods may be feasible, they may currently be impractical. That is, because Faradaic efficiency drift is caused by a large number of independent operating condition variables, a predictive-knowledge-type dynamic BPED operating approach would require a complicated sensor network that would be expensive to install and maintain. Moreover, some of the independent operating condition variables (e.g., scale build-up) may be difficult or impossible to directly monitor in real time using commercially available sensors. Further, a dynamic BPED operating approach would require the development of a machine learning or artificial intelligence engine capable of processing the large amounts of sensor data and adjusting the BPED's operating state in a way that optimizes base production efficiency for every possible combination of independent operating condition variable values-such an approach would require significant time and resources to develop and significant processing and memory resources to implement.

What is needed is a simple and reliable method for automatically optimizing the production efficiency of BPEDs of the type utilized in OAE systems. In particular, what is needed is a control method that automatically corrects BPED operations without requiring predictive knowledge of the independent operating condition variables that cause Faradaic efficiency drift.

### SUMMARY OF THE INVENTION

The embodiments described herein are directed to a production efficiency optimization process for a bipolar electrodialysis device (BPED) that automatically corrects for Faradaic efficiency drift by systematically modifying BPED control parameters in a way that maximizes production efficiency (i.e., the ratio of base or acid molecules produced to the amount of power consumed). The production efficiency optimization process applies incremental changes to the BPED's operating state (i.e., by way of modifying a selected BPED control parameter) and utilizes measured changes in base/acid production and power consumption to determine whether each applied control parameter modification caused an increase (improvement) or decrease (worsening) in BPED production efficiency, whereby the direction (increase or decrease) of each sequentially applied control parameter modification is systematically biased toward improved production efficiency based solely on the direction and result (improvement/worsening) of the immediately preceding control parameter modification. Systematically modifying BPED control parameters in this way facilitates automatic correction for the gradual decline in BPED operating efficiency caused by Faradaic efficiency drift without requiring predictive knowledge of the independent operating condition variables causing the Faradaic efficiency drift. Therefore, the production efficiency optimization process substantially reduces the complexity of the required sensor network (i.e., in comparison to predictive knowledge approaches) because BPED production efficiency can be determined using a relatively small number of commercially available sensors. Moreover, the production efficiency optimization process requires substantially less processing and memory resources (i.e., improves computer functionality in comparison to predictive knowledge approaches) because the BPED production efficiency calculations are implemented using only real-time data, thereby eliminating the significant processing and data storage resources required to implement machine learning or artificial intelligence engines.

In an embodiment, the production efficiency optimization process is directed to BPEDs of a size and type utilized by ocean alkalinity enhancement (OAE) systems. Such BPEDs are typically configured to electrochemically process salt (NaCl) to produce base substance (NaOH molecules) at a rate of 1,000 tons or more per year, thereby enabling OAE systems to both reduce atmospheric carbon dioxide (CO₂) and mitigate ocean acidification by generating and supplying an ocean alkalinity product to the world's oceans. As set forth above, minimizing LCOC is critical to an OAE system's acceptance/deployment and is strongly dependent on BPED base production efficiency, so in the context on an OAE system the production efficiency optimization process is utilized to control BPED operations in a way that optimizes (maximizes) base production efficiency. However, BPEDs of the size and type used in OAE systems may be used to produce base substances for other purposes. Moreover, the electrochemical process used by BPEDs for base production also produces a comparable amount of acid substance (HCl molecules), and the production efficiency optimization process may be easily modified to control BPED operations in a way that optimizes acid production efficiency (i.e., instead of base production efficiency). Therefore, BPEDs of the size and type used in OAE systems may also be used in systems in which the BPED's acid production is valued over base production (e.g., in systems requiring a steady supply of HCl to perform a manufacturing process). Accordingly, although the production efficiency optimization process is primarily described below in an OAE system context with reference to maximizing base production efficiency, the production efficiency optimization process may also be utilized to maximize either base production efficiency or acid production efficiency in other (non-OAE) systems.

In an embodiment, production efficiency optimization process systematically modifies (increases or decreases) a selected BPED control parameter in response to measured improvements in production efficiency caused by an immediately preceding modification to the selected BPED control parameter. A first BPED production efficiency level is determined from base/acid production and power consumption sensor data, and a first production efficiency value is while the BPED is in a first operating state (i.e., a BPED operating state generated while all BPED control parameters are maintained at corresponding initial values). A first incremental modification is applied to the selected BPED control parameter (e.g., stack current) in a first direction (i.e., either an incremental increase or incremental decrease), thereby causing the BPED to change from the first operating state to a second operating state (i.e., a BPED operating state generated after the selected BPED control parameter is changed from its initial value to the modified value, and all other BPED control parameters are maintained at their corresponding initial values). A second BPED production efficiency level is then determined from base/acid production and power consumption sensor data while the BPED is in the second operating state, and a corresponding second production efficiency value is generated. The first and second production efficiency values are then compared to determine if the first BPED control parameter modification improved or worsened the BPED's production efficiency (i.e., whether the BPED's production efficiency while in the second operating state is greater than or less than the BPED's production efficiency while in the first operating state. When the comparison results indicate that the first BPED control parameter modification improved the BPED's production efficiency, then the (second) direction of the next subsequent (second) modification is made equal to the first direction (i.e., both the first and second modifications are incremental increases or incremental decreases). Conversely, when the comparison results indicate that the first BPED control parameter modification worsened the BPED's production efficiency, then the (second) direction of the next subsequent (second) modification is made opposite to the first direction (i.e., if the first modification was an increase, the second modification is a decrease, or if the first modification was a decrease, the second modification is an increase). By systematically applying incremental BPED control parameter modifications that utilizes each resulting differential change in BPED production efficiency to bias the direction of a next subsequently applied incremental BPED control parameter modification, the production efficiency optimization process adjusts BPED operations in real time using substantially fewer sensors and less processing time/resources (i.e., improves computer functionality in comparison to predictive-knowledge-based approaches).

As mentioned above, generating each of the two production efficiency values (i.e., before and after each applied incremental control parameter modification) involves determining the acid/base production rate and corresponding rate of power consumption that occurs during each associated BPED operating state. For example, when the production efficiency optimization process is utilized to optimize base production efficiency, the base production efficiency value generated before each incremental change is determined using base production rate data and power consumption rate data that is measured (collected/generated) immediately before the incremental change is applied. In one embodiment, each production efficiency value is generated as a base-product-to-power (B/P) ratio value by calculating a base production rate value (e.g., a measured base solution stream flow rate times a difference between base concentrations in the base solution stream measured both upstream and downstream from the IE stack), and then dividing by a corresponding power consumption rate value that is determined, for example, by measuring the rate of total OAE system power consumption during production of the measured base substance. In alternative embodiments, each production efficiency value is generated as an acid-product-to-power (A/P) ratio value calculated using flow rate and concentration data measured from the acid solution stream and dividing by a corresponding power consumption rate value. This approach both minimizes the number of sensors required to collect the necessary data and the processing resources required to calculate the acid/base production efficiency values. Moreover, by utilizing the production efficiency optimization process to optimize base production efficiency in an OAE system (i.e., where the BPED includes a post-production device suitable for generating an ocean alkalinity product), the production efficiency optimization process also serves to meet the need for measurability and verification (i.e., by way of utilizing the generated base production data to verify the amount of base substance included in the ocean alkalinity product). By utilizing this sensor network and data stream additional hardware can eliminated reducing overall system cost and complexity.

In accordance with an aspect, the direction (increase or decrease) of the next sequential (second) control parameter modification is determined by the direction of the previous (first) control parameter modification and by the comparison between the (first) production efficiency value measured before application of the previous (first) control parameter modification and the second production efficiency value measured after application of the previous (first) control parameter modification. In the embodiments described herein, the production efficiency values are generated as B/P ratio values or A/P ratio values such that the second production efficiency value is greater than (has a higher numeric value in comparison to) the first production efficiency value when BPED production efficiency is improved by the previous (first) control parameter modification, and the first production efficiency value is greater than the second production efficiency value when BPED production efficiency is worsened by the previous (first) control parameter modification. Therefore, the production efficiency optimization process systematically improves BPED production efficiency by biasing the direction of the next subsequently (second) control parameter modification such that it equals the direction of the previous (first) control parameter modification (i.e., both the first and second control parameter modifications involve increases or incremental decreases) when the second production efficiency value is greater than the first production efficiency value, and such that it is opposite to the direction of the previous (first) control parameter modification (i.e., the first control parameter modification involves an increase and the second control parameter modification involves a decrease, or the first control parameter modification involves a decrease and the second control parameter modification involves an increase) when the second production efficiency value is less than the first production efficiency value. By utilizing the differential change resulting from the comparison of BPED production efficiency values to bias the direction of subsequently applied control parameter modifications in this manner, the production efficiency optimization process greatly simplifies the optimization of BPED operations in real time over conventional approaches.

In one embodiment, each control parameter modification involves changing (i.e., increasing or decreasing) the relevant control parameter by an incremental amount (e.g., an amount in the range of 1% to 10%). For example, when the currently selected (first) control parameter is stack current and the initial stack current set-point is 50 mA/cm², the next sequential control parameter modification in an increase direction involves changing the initial set-point value from 50 mA/cm² to a modified value in the range of 50.5 mA/cm 2 to 55 mA/cm². For reasons explained below, the purpose of each control parameter modification is to generate a corresponding measurable change in BPED production efficiency, so the minimum modification amount is large enough to generate a measurable production efficiency change. Conversely, if the incremental amount of each applied modification is too large, then the optimization process may not be sufficiently precise. In some embodiments, the incremental amount of each control parameter modification is a predetermined amount (i.e., based on experimental or test optimization processes or a stored average calculated from previously executed optimization processes). In other embodiments, the incremental amount of each applied modification may be varied during optimization process (e.g., initially set at 10% and then gradually/incrementally decreased to 1%) to facilitate achieving more precise BPED production efficiency optimization.

In some embodiments, modifying a BPED control parameter involves incrementally changing the stack current, the concentration of salt, acid or base substance in one of the salt, acid or base solution streams, or the flow rate of one of the salt, acid or base solution streams. When the BPED is in a sub-optimal operating state, an incremental modification applied to one of these BPED control parameters affects the chemical (base/acid production) and/or electrical (power consumption) aspects of the electrochemical process performed in the IE stack, thereby producing a change in the BPED's Faradaic efficiency and a corresponding change in the BPED's production efficiency. For example, incrementally increasing the amount of stack current passed through the IE stack increases the conversion rate of salt to base and acid (i.e., causes a corresponding increase in acid/base production), thereby affecting the BPED's production efficiency, and simultaneously the resultant increased voltage increases a shunt current generated within the IE stack, thereby lowering the Faradaic efficiency. As mentioned above, it is difficult to maintain a BPED at optimal production efficiency due to the gradual changing (drifting) and coupled nature of the BPED's Faradaic efficiency, and it would be impractical to detect/measure gradual changes in the large number of independent operating condition variables that collectively produce the Faradaic efficiency drift. By utilizing the differential change (i.e., improvement or worsening) in production efficiency resulting from each incremental modification of one of the above-mentioned control parameters to bias the direction (increase or decrease) of each subsequent control parameter modification, the production facilitates improving/optimizing BPED production efficiency using significantly fewer sensors and processing resources than would be required to measure/process the independent operating condition variables responsible for Faradaic efficiency drift.

In an embodiment each control parameter modification is entered as set-point value that is converted into one or more control signals utilized to control relevant BPED control devices (e.g., current/voltage generators, pumps or valves), whereby the applied control parameter modification changes the BPED's operating state. For example, when the selected control parameter is associated with the IE stack current, each modification involves modifying (changing) the stack current's set-point value. The set-point value modification causes a corresponding stack current control signal to change, which in turn causes a stack current generator to generate different stack current through the IE stack, thereby increasing the stack's ability to convert salt to acid/base substance. In another example the selected control parameter modification involves modifying a set-point value associated with the base substance concentration of the base stream directed through the IE stack. The set-point modification produces an associated update to a corresponding recycle fraction control signal that causes a base recycle valve to change the base recycle fraction returned from the IE stack to a base holding tank, which in turn causes a change in the base substance concentration. In yet another example the selected control parameter modification involves modifying a set-point value associated with the salt solution flow rate through the IE stack. The set-point modification produces an associated update to a corresponding pump control signal that causes a pressure control pump to change the flow rate of the strong salt stream fed to the IE stack to a base holding tank, thereby increasing the amount of salt available for conversion to acid/base substance. In a similar manner, other BPED control parameters (e.g., salt concentration, acid concentration, acid flow rate, and base flow rate) can be systematically modified. The use of set-point values to keep track of BPED control parameters facilitates a broad range of additional BPED control functions, such as adjusting flow rates to match IE stack cross pressures.

In some embodiments, the production efficiency optimization process sequentially performs systematic modification (as described above) on multiple control parameters, where systematic modification is performed on each control parameter until a maximum BPED production efficiency level is detected. That is, the systematic modification of a selected (first) control parameter (e.g., stack current) is performed as described above during a first time period that ends when a comparison result indicates that a first maximum production efficiency level was achieved, whereby a different (second) control parameter (e.g., base/acid concentration or salt flow rate) is designated as the selected control parameter, and the systematic modification of the selected control parameter is performed as described above during a second time period that ends when a comparison result indicates that a second maximum production efficiency level has been achieved. As mentioned above, each modification to a selected BPED control parameter causes a corresponding change in the BPED's production efficiency (i.e., by way of changing the acid/base production rate and/or the associated power consumption). It was found that systematically modifying different control parameters produced non-linear changes to the dynamic Faradaic efficiency (e.g., at some flow rates stack current modifications produce a significant change to the BPED's Faradaic efficiency, but at others the flow rate is dominant). It was also found that alternately performing systematic modification on two or more control parameters more effectively corrects for Faradaic efficiency drift because the maximum production efficiency level achievable by modifying one control parameter may be lower than the maximum production efficiency level achievable by modifying another (different) control parameter. For example, systematically modifying the IE stack current may be used to achieve a maximum base/acid production efficiency value at a given BPED Faradaic efficiency, but an even higher maximum production efficiency value may be achieved by way of changing the BPED's Faradaic efficiency through the systematic modification of base concentration, acid concentration and/or salt flow rate. Therefore, by sequentially performing systematic modification using two or more different control parameters, the production efficiency optimization process facilitates a higher level of BPED production efficiency optimization than would be possible if systematic modification was applied to only one control parameter. It was also found that optimizing base (and acid) production efficiency was even more successful by alternately systematically modifying three or more parameters (e.g., switching between stack current, then base concentration and then salt flow rate to maximize base production efficiency, and switching between stack current, then acid concentration and then salt flow rate to maximize acid production efficiency). Further, by continuously looping or otherwise alternating between two or more control parameters (i.e., such that one control parameter is being systematically modified at all times during post-start-up BPED operations), the production efficiency optimization process adjusts BPED operations in real time to track the gradual change in optimal faradic efficiency level associated with Faradaic efficiency drift in real time.

In an embodiment the BPED operating method utilizes a start-up process to achieve steady-state acid/base production (i.e., electrochemical process) operations before executing the production efficiency optimization process. An initial start-up process is performed at power up, including safety checks and systematically operating the BPED's control devices in a way that safely ramps up the flow of salt, base and acid solution streams through the IE stack, and ends by ramping up the applied stack current until it is substantially equal to (e.g., within 10% of) a predetermined initial stack current set-point value. Once the initial start-up process is completed, acid/base production is ramped up using a predefined set of initial control parameter values to control BPED operations while a set of operably disposed sensors to generate corresponding measured control parameter values. The BPED is controlled by this acid/base production ramp-up process until the BPED achieves steady-state operations, and then the BPED is controlled using the production efficiency optimization process as described above. In an embodiment, the measured control parameter values are compared with corresponding initial set-point values during the acid/base production ramp-up process, and steady-state operation is achieved when each measured control parameter value is sufficiently equal to (e.g., within 10% of) its corresponding initial set-point value. In one embodiment, the BPED's control devices are specifically operated during the acid/base production ramp-up process with primary focus on the salt solution stream, and then with primary focus on the base stream, and then with primary focus on the acid stream. That is, the control devices are specifically operated with primary focus on the salt solution stream until all measured salt-related control parameter values indicate that all salt related control parameters (e.g., salt concentration, salt stream pressure and salt stream flow rate) are sufficiently equal to the corresponding initial salt-related control parameter values, and then this process is performed with primary focus on the base stream control parameters (i.e., until all measured base-related control parameter values are sufficiently equal to the corresponding initial base-related control parameter values), and then the process is performed a third time with focus on the acid stream control parameters. By combining this start-up process with the production efficiency optimization process, BPEDs that are operated in accordance with the operating method described herein spend less operational time in a non-optimized state than those operated using conventional methods.

In an embodiment an electrochemical ocean alkalinity enhancement (OAE) system includes a controller that is configured to control the operations of a BPED such that the BPED's base production efficiency is optimized in the manner described above, and such that the base substance produced by the BPED is incorporated into an ocean alkalinity product that is supplied to the ocean to capture atmospheric carbon dioxide and mitigate ocean acidification. In an alternative embodiment, a method for controlling an OAE system utilizes the BPED operating method described herein.

### BRIEF DESCRIPTION OF THE DRAWINGS

These and other features, aspects and advantages of the present invention will become better understood with regard to the following description, appended claims, and accompanying drawings, where:

FIG. 1 is a simplified diagram depicting an OAE system including a BPED that is controlled using a production efficiency optimization process in accordance with a generalized embodiment;

FIGS. 2A and 2B are graphs depicting exemplary relationships between base/acid production, power consumption, production efficiency and Faradaic efficiency during operation of the BPED depicted in FIG. 1;

FIG. 3 is a diagram depicting the flow control and electrical systems of an exemplary BPED according to an embodiment;

FIG. 4 is a simplified diagram depicting control devices and sensors that are utilized to implement the production efficiency optimization process according to an embodiment;

FIG. 5 is a table depicting control parameters and their associated set-point and measured values utilized during implementation of the production efficiency optimization process according to an embodiment;

FIG. 6 is a flow diagram depicting a BPED operating method including a base production efficiency optimization process according to an embodiment;

FIG. 7A is a flow diagram depicting an initial BPED start-up process utilized by the BPED operating method of FIG. 6 according to an exemplary embodiment;

FIG. 7B is a flow diagram depicting a base/acid production ramp-up process for achieving steady-state operation of a BPED before executing the base production efficiency optimization process according to an embodiment;

FIG. 8 is a flow diagram depicting a stack current modification procedure that is utilized during the base production efficiency optimization process of FIG. 6 according to an embodiment;

FIGS. 9A and 9B are graphs depicting the use of the stack current modification procedure of FIG. 8 to optimize a BPED's base production efficiency according to exemplary embodiments;

FIG. 10 is a flow diagram depicting a base concentration modification procedure that is utilized during the base production efficiency optimization process of FIG. 6 according to an embodiment;

FIGS. 11A and 11B are graphs depicting the use of the base concentration modification procedure of FIG. 10 to optimize a BPED's base production efficiency according to another exemplary embodiment; and

FIG. 12 is a flow diagram depicting a salt concentration modification procedure that is utilized during the base production efficiency optimization process of FIG. 6 according to an embodiment.

### DETAILED DESCRIPTION OF THE DRAWINGS

The embodiments described herein relate to an improvement in methods and systems for improving the operating efficiency of a bipolar electrodialysis device (BPED) of a size and type utilized in an electrochemical ocean alkalinity enhancement (OAE) system. The following description is presented to enable one of ordinary skill in the art to make and use the methods and systems described herein as provided in the context of specific embodiments. Various modifications to the embodiments will be apparent to those with skill in the art, and the general principles defined herein may be applied to other embodiments. Therefore, the methods and systems described herein are not intended to be limited to the particular embodiments shown and described but are to be accorded the widest scope consistent with the principles and novel features herein disclosed.

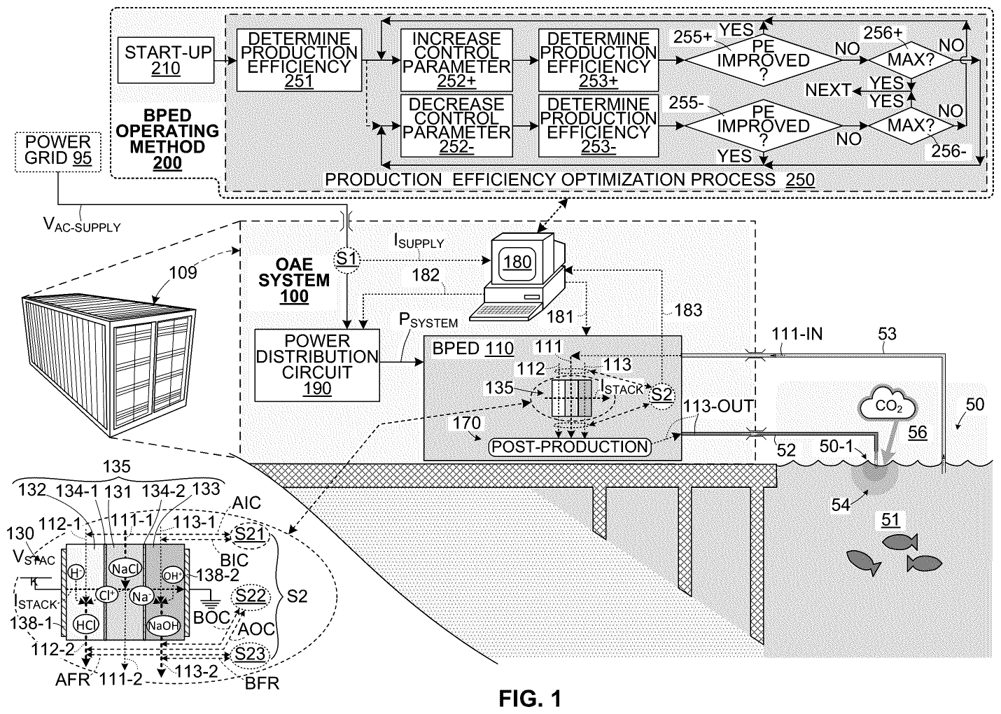

FIG. 1 shows a generalized OAE system 100 that is configured to capture carbon dioxide (CO₂) from earth's atmosphere and mitigate ocean acidification by generating and supplying an ocean alkalinity product 113-OUT (i.e., an aqueous solution having a pH>8 and comprising salt and a dissolved base substance) to seawater 51 (ocean 50) at a selected outfall location 50-1. In one embodiment OAE system 100 is located adjacent to ocean 50 and ocean alkalinity product 113-OUT is transported (supplied) to outfall location 50-1 by way of being pumped through an outflow transfer pipe 52, whereby the base substance supplied with alkalinity product 113-OUT gradually diffuses (disperses) into seawater 51 surrounding outfall location 50-1 (e.g., as depicted by region 54 in FIG. 1), and the resulting increased alkalinity of seawater 51 reduces ocean acidification and increases the ocean's ability to absorb/capture atmospheric CO₂ (e.g., from atmospheric region 56 located over seawater 51). In one embodiment, OAE system 100 carefully controls the composition and supply (outflow quantity) of ocean alkalinity product 113-OUT to prevent harm to sea life that can be caused by dangerously high seawater pH levels near outfall location 50-1, which may occur if the base substance in ocean alkalinity product 113-OUT is supplied in an uncontrolled (e.g., continuous or highly concentrated) manner into seawater 51. While outfall location 50-1 is depicted as a single location, in practice, alkalinity product 113-OUT may be supplied to ocean 50 at multiple outfall locations in space and time.

OAE system 100 generally includes at least one BPED 110, a control circuit 180 and an optional power distribution circuit 190 that may be disposed within a housing (e.g., a modified shipping container) 109. As described in detail below, BPED 110 is of a type that electrochemically processes salt provided in a feedstock (salt/saline) solution 111-IN and is of a size that is capable of generating ocean alkalinity product 113-OUT in a sufficient quantity to increase the alkalinity of a designated ocean area. When OAE system 100 includes two or more BPEDs, each BPED is configured and operates as described below with reference to BPED 110, and the operation of each BPED is independently optimized using the production efficiency optimization process described below. In some embodiments, feedstock solution 111-IN includes seawater 51 that is pumped directly from ocean 50 through an inflow transfer pipe 53. In other embodiments (not shown), feedstock solution 111-IN may comprise brine generated by a brine source (e.g., a desalination plant or a water recycling plant that processes seawater and generates brine as a byproduct). Control circuit 180 can be an electronic device (e.g., a computer/processor or dedicated electronic device) that implements software-based instructions or is otherwise configured to execute various system-related software-based programs including a BPED operating method 200 (indicated at the top of FIG. 1 and described below) that controls the operations performed by BPED 110, and other control algorithms/processes that control the operations of other system devices (e.g., optional power distribution circuit 190) in a fully autonomously manner. In some embodiments, control circuit 180 is also configured to control BPED 110 during maintenance and other operations in the manner described in co-owned U.S. patent application Ser. No. 17/838,967, entitled “OCEAN ALKALINITY SYSTEM AND METHOD FOR CAPTURING ATMOSPHERIC CARBON DIOXIDE”, which is incorporated herein by reference in its entirety. Optional power distribution circuit 190 can be configured to convert externally supplied alternating-current (AC) electrical power V_{AC-SUPPLY}, which is received from an external source (e.g., a power grid 95), into a suitable OAE system power P_{SYSTEM} that can be used to facilitate various OAE system operations. In one embodiment, power distribution circuit 190 may be controlled by control circuit 180 (e.g., by way of control signals 182) to supply system power P_{SYSTEM} to BPED 110 during periods in which ocean alkalinity product 113-OUT is generated.

Referring to the center of FIG. 1, BPED 110 generally includes an ion exchange (IE) stack 135 and one or more post-production devices 170. BPED 110 also includes flow control resources (not shown in FIG. 1 but are described below) that are configured to direct a salt solution stream 111, an acid solution stream 112 and a base solution stream 113 through respective separate flow channels formed in stack 135, where salt solution stream 111 includes or is produced from feedstock solution 111-IN (e.g., using zero or more pre-production processes/devices mentioned below), and where acid solution stream 112 and base solution stream 113 are generated and supplied to IE stack 135 using the methods mentioned below. IE stack 135 is configured to electrochemically process salt disposed in salt solution stream 111 to generate a base substance in base solution stream 113 and an acid substance in acid solution stream 112. That is, the amount of salt (salt concentration) in salt solution stream 111 is higher before entering IE stack 135 than after leaving IE stack 135. Conversely, the amount of acid substance (acid concentration) in acid solution stream 112 and the amount of base substance (base concentration) in base solution stream is lower before entering IE stack 135 and higher upon leaving IE stack 135. In one embodiment, changes in salt, acid and base concentration are measured by sensors S2 positioned upstream and downstream from IE stack 135 and transmitted as sensor data on signal lines 183 to controller 180 for purposes described below. As indicated below IE stack 135, post-production device 170 receives one or more of the solution streams leaving IE stack 135 and may be configured to process one or more of the base substance and acid substance produced by the electrochemical process performed in IE stack 135. For example, post-production device 170 may be configured to generate ocean alkalinity product 113-OUT using at least some of the base substance generated in base solution stream 113 by IE stack 135.

Referring to the bubble section appearing in lower left portion of FIG. 1, IE stack 135 includes a salt flow channel 131, an acid flow channel 132 and a base flow channel 133 that are respectively separated by ion exchange membranes 134-1 and 134-2 and are configured to conduct the salt, acid and base solution streams. For descriptive purposes, inflowing/upstream solution stream portions (i.e., stream portions flowing into the upper/input end of IE stack 135) are indicated with the suffix “−1”, outflowing/downstream solution stream portions are indicated with the suffix “−2”, and the terms “weak” and “strong” are used herein to indicate the relative concentrations of salt, acid and base substances in the upstream/downstream salt, acid and base solution stream portions. That is, to indicate the removal of salt molecules by the electrochemical process described below, upstream salt solution stream portion is referred to as strong salt stream 111-1 and the downstream portion is referred to as weak salt stream 111-2 (i.e., because of the removal of salt molecules by the electrochemical processing described above). In contrast, to indicate the addition of acid/base substance to the acid and base streams by the electrochemical process, the upstream acid/base solution stream portions are referred to as weak acid stream 112-1 and weak base stream 113-1, and the downstream portions are referred to as strong acid stream 112-2 and strong base stream 113-2.

As indicated in the bubble section, IE stack 135 forms part of an electrodialysis apparatus 130 including additional structures, sensors and systems that facilitate the electrochemical processing of salt molecules (NaCl) disposed in strong (inflowing) salt solution stream 111-1 to produce both an acid substance (HCl) in strong (outflowing) acid solution stream 112-2 and a base substance (NaOH) in strong (outflowing) base solution stream 113-2. For example, electrodialysis apparatus 130 includes manifold or other structures (not shown) that are configured to direct strong salt stream 111-1 into the inlet of salt flow channel 131, to direct weak acid stream 112-1 into the inlet of acid flow channel 132, and to direct weak base stream 113-1 into the inlet of base flow channel 133. Electrodialysis apparatus 130 also includes opposing electrodes (e.g., an anode 138-1 and a cathode 138-2) positioned on opposite sides of IE stack 135 such that, when solution streams 111-1, 112-1 and 113-1 are passed through flow channels 131, 132 and 133, respectively, and a suitable stack voltage V_{STACK} is applied across electrodes 138-1 and 138-2, a stack current I_{STACK} is conducted by the flowing solutions and through the intervening ion exchange membranes 134-1 and 134-2 (i.e., as depicted by the dot-line arrow extending from anode 138-1 to cathode 138-2). Referring to salt flow channel 131, when a suitably strong stack current I_{STACK} is conducted through stack 135, at least some of the salt molecules (NaCl) in the portion of salt solution stream 111-1 disposed in flow channel 131 are electrochemically processed (ionized), thereby producing sodium ions Na⁻ and chlorine ions Cl⁺ that are attracted to the positive (V_{STACK}) and negative (ground) potentials applied to electrodes 138-1 and 138-2, respectively. As depicted in acid flow channel 132, ion exchange membrane 134-1 is configured such that chlorine ions Cl⁺ migrate from flow channel 131 through ion exchange membrane 134-1 toward anode 138-1 and combine with hydrogen ions H⁻ to form hydrochloric acid molecules (HCl) in flow channel 132, whereby strong acid stream 112-2 has a higher acid concentration than weak acid stream 112-1. Similarly, as depicted in base flow channel 133, sodium ions Na⁻ migrate from salt flow channel 131 through ion exchange membrane 134-2 toward cathode 138-2 and combine with hydroxide ions OH⁺ to form sodium hydroxide molecules (NaOH) in flow channel 133, whereby strong base stream 113-2 has a higher base concentration than weak base stream 113-1.

The execution of BPED operating method 200 by control circuit 180 is described herein with reference to the systematic modification of BPED control parameters. Each of the BPED control parameters is associated with a measurable physical property of the electrochemical process performed in IE stack 135 (e.g., voltage/current level, pressure level, concentration level or flow rate), and modification of a selected BPED control parameter is achieved by way of modifying the operating state(s) of one or more of the BPED control devices that affect the associated measurable physical property (i.e., by transmitting appropriate “modified” control signal(s) to the control device(s)). In one embodiment, each BPED control parameter is represented by an associated set-point value (i.e., a processor-controlled input variable that sets a desired amount/level of the associated control parameter), whereby controller 180 modifies a selected control parameter by changing its associated set-point value (i.e., changing the numeric value stored at a memory location designated for the selected control parameter) and transmitting associated control signal(s) to the relevant BPED control devices, thereby altering the BPED's operating state in a way that achieves the desired amount/level indicated by the set-point value modification. For example, increasing the flow rate of salt solution stream 111-1 into IE stack 135 involves applying an appropriate modification to the associated salt flow rate control parameter set-point value, which in turn causes the transmission of an updated control signal having a digital or analog magnitude/value that causes a salt input pump to increase flow rate of salt solution stream 111-1 by an amount corresponding to the applied set-point value modification. For brevity and clarity, the systematic modification of a selected control parameter is described herein with primary reference to changes to the selected control parameter's set-point value, and that the updated control signal transmissions that produce the required control device operating state changes are omitted. In one embodiment, the set-point value (magnitude) of each control parameter falls within a predetermined range (e.g., from zero (0) to one hundred (100)), whereby the operating state of each BPED control device is controllable by way of modifying its associated control parameter (i.e., by way of modifying/changing the set-point value of the associated control parameter). For example, assume the opened/closed operating state of a valve-type BPED control device is determined such that flow through the valve is prevented (i.e., the valve is controlled to enter a fully closed state) when the set-point value of the associated control parameter is set to zero (0), and such that flow through the valve is maximized (i.e., the valve is controlled to enter a fully opened state) when the set-point value is one hundred (100). In this example, control circuit 180 changes (increases or decreases) the rate of flow through the valve by way of modifying (increasing or decreasing) the associated parameter's set-point value (e.g., where increasing the control parameter's set-point value causes the transmission of an associated control signal to the valve an increased flow rate through the valve and decreasing the control parameter's set-point value causes a decreased flow rate through the valve).

As defined herein, the operating state of BPED 110 is determined by the collective operating states of all of the BPED control devices, whereby modifying (changing) the operating state(s) of one or more of the control devices in response to the modification of a selected control parameter necessarily produces a change to the BPED's operating state. For example, at a given point in time the operating state of BPED 110 is determined by a level of stack current I_{STACK} and a flow rate of salt solution stream 111-1 through IE stack 135, where the specific stack current level and salt flow rate are determined by the operating states of associated control devices in accordance with specific control parameter values (e.g., a specific stack current set-point value and a specific salt flow rate set-point value) at that time. A subsequent change (modification) to either of the stack current set-point value or the salt flow rate set-point value causes a change in the operating state of one or more corresponding control devices (i.e., causing a current source to increase/decrease the level of stack current I_{STACK} or causing a pump to increase/decrease the flow rate of salt solution stream 111-1), thereby changing the operating state of BPED 110.

As described in additional detail below, BPED operating method 200 includes a production efficiency optimization process 250 that utilizes real time power consumption and production efficiency data to optimize base or acid production efficiency by BPED 110. In one embodiment, real time power consumption data is generated using a sensor S1 (e.g., a potentiometer or voltmeter) that is configured using known techniques to generate supply current data I_{SUPPLY}, which indicates the rate at which supply current is drawn from power grid 95, whereby control circuit 180 is able to calculate the rate of total system power consumption by OAE system 100 (or amount during a given time period) using the corresponding supply current I_{SUPPLY} and the supply voltage V_{AC-SUPPLY}. In other embodiments (not shown), sufficiently accurate real time power consumption may be determined using other methods, such as by measuring the amount of system power P_{SYSTEM} supplied to BPED 110.

Production efficiency and other data is collected by sensors S2 disposed in BPED 110 that are configured to collected concentration and flow rate data from one or more of the solution streams passing through IE stack 135 as described above. Referring again to the bubble section of FIG. 1, in one embodiment, sensors S2 may include one or more inflow base/acid concentration sensors S21, one or more outflow base/acid concentration sensors S22 and one or more base/acid flow rate sensors S23. Inflow base/acid concentration sensors S21 may be configured to generate base inflow concentration data BIC and/or acid inflow concentration data AIC (e.g., one or more sensors configured to measure conductivity, pH and/or density of weak acid stream 112-1 and/or weak base stream 113-1). Outflow base/acid concentration sensors S21 may be similarly configured to generate base outflow concentration data BOC and/or acid outflow concentration data AOC from strong acid stream 112-2 and/or strong base stream 113-2. Finally, flow rate sensors S23 may be pressure gauges or otherwise configured to measure the volumetric base flow rate BFR or acid flow rate AFR of the base solution stream and/or acid solution stream passing through IE stack 135. The various types of sensor data mentioned above may be utilized by controller 180 to control BPED 110 as described below.

Referring to the upper portion of FIG. 1, in one embodiment BPED operating method 200 includes a start-up process 210 and a production efficiency optimization process 250. In one embodiment, control circuit 180 utilizes start-up process 210 to control operations of BPED 110 from an idle (i.e., fully stopped or non-production) operating state to a pre-defined operational steady-state. When BPED 110 achieves steady-state operations (e.g., such that BPED 110 generates and supplies ocean alkalinity product 113-OUT to ocean 50), control circuit 180 utilizes production efficiency optimization process 250 to optimize the production efficiency of BPED 110 in the manner described below.

Production efficiency optimization process 250 begins by determining an initial production efficiency level of BPED 110 and generating an initial (first) production efficiency value while BPED 110 is in a first operating state (block 251). In one embodiment, determining the initial production efficiency level involves utilizing sensors S1 and S2 to collect associated sensor data and transmitting the sensor data to controller 180 while BPED 110 is in the first operating state. Note that the initial BPED production efficiency level may comprise either a base production efficiency level or an acid production efficiency level. When a base production efficiency level is required, upstream base/acid concentration sensors S21 are utilized to measure an inflow (first) base substance concentration BIC from weak base stream 113-1, downstream base/acid concentration sensors S22 are utilized to measure an outflow (second) base substance concentration BOC from strong base stream 113-2, and flow rate sensors S23 are utilized to measure an initial (first) base flow rate value BFR. These sensor data values are transmitted to controller 180, which calculates an initial base substance production rate by multiplying the base flow rate value times a difference between the inflow and outflow base concentrations (i.e., [BOC-BIC]×BFR, which indicates the rate of the number of NaOH atoms added to strong base solution stream 113-2), and then divides the base substance production rate by a power consumption value (e.g., using data received from sensor S1) to generate the required production efficiency value in the form of a base-product-to-power (B/P) ratio value. In an alternative embodiment in which an acid production efficiency level is required, upstream base/acid concentration sensors S21 are utilized to measure an inflow acid substance concentration AIC from weak acid stream 112-1, downstream base/acid concentration sensors S22 are utilized to measure an outflow (second) acid substance concentration AOC from strong acid stream 112-2, and flow rate sensors S23 are utilized to measure an initial (first) acid flow rate value AFR, and controller 180 calculates an initial acid substance production rate (e.g., using the equation [AOC-AIC]×AFR, which indicates the rate of the number of HCl atoms added to strong acid solution stream 112-2) and then divides by the acid substance production rate by a power consumption value to generate the required production efficiency level in the form of an acid-product-to-power (A/P) ratio value.

Next, production efficiency optimization process 250 modifies a selected BPED control parameter in a selected (first) direction (i.e., increase or decrease, as indicated by block 252+ and 252−). For reasons that will become clear below, the direction (increase or decrease) of the control parameter modification applied immediately after execution of block 251 may be randomly selected (i.e., the outcome of the process does not depend upon whether control passes from block 251 to block 252+ as indicated by the solid line arrow, or whether control passes to block 252− along the dashed-line arrow). Similarly, the first control parameter chosen for modification may also be randomly selected, provided the control parameter is selected from a group of control parameters whose modification affects at least one of the chemical (base/acid production) and electrical (power consumption) aspects of the electrochemical process performed in IE stack 135 (i.e., such that a modification applied to a control parameter from this group produces both a change in the BPED's Faradaic efficiency and a corresponding change in the BPED's production efficiency. In an embodiment in which optimizing base production efficiency may be desired, the group of control parameters may include stack current (e.g., a set-point value used to control a magnitude of stack current I_{STACK} applied through IE stack 135) base concentration (e.g., a set-point value utilized to control the amount/concentration of base substance in weak base stream 113-1) and salt flow rate (e.g., a set-point value used to control the volumetric flow of salt solution through salt chamber 131 of IE stack 135). In an alternative embodiment in which optimizing acid production efficiency may be desired, the group of control parameters may include stack current, acid concentration (a set-point value utilized to control the amount/concentration of acid substance in weak acid stream 112-1) and salt flow rate. Other control parameters that may be modified in accordance with the spirit of blocks 252+/− include salt concentration (e.g., a set-point value, when available, that can be utilized to control the amount/concentration of salt in strong salt stream 111-1), acid flow rate (e.g., a set-point value used to control the volumetric flow of acid solution through acid chamber 132 of IE stack 135) and base flow rate (e.g., a set-point value used to control the volumetric flow of base solution through base chamber 133 of IE stack 135). As mentioned above, modifying a selected one of these control parameters results in a corresponding operating state change of at least one BPED control device, thereby causing a change in the operating state of BPED 110 from the (first) operating state (i.e., the operating state when the initial production efficiency value was generated, as described above with reference to block 251) to a (second) operating state determined in part by the applied control parameter modification.

After applying the control parameter modification per block 252+ or block 252−, a (second) production efficiency level of BPED 110 is determined and a (second) production efficiency value is generated while BPED 110 is in the second operating state (blocks 253+ and 253−). Note that blocks 253+ and 253− are distinguished only by its associated preceding block (i.e., after an increase-type modification is applied per block 252+, control passes to block 253+; conversely, after a decrease-type modification is applied per block 252−, control passes to block 253−), and that the operation performed in accordance with either block 253+ or 253− is substantially identical to the operation performed in block 251 (described above). In one embodiment, the operation of block 253+ (or block 253−) is executed a predetermined delay period after the control parameter modification applied in block 252+ (or block 252−) to allow the applied modification to generate an associated measurable change in BPED operations.

After the (second) production efficiency value is generated per block 253+ (or block 253−), the first and second production efficiency values are compared and then control passes to block 255+ (or block 255−), where controller 180 determines if the change in BPED operations resulting from the modification applied in block 252+ (or block 252−) caused BPED production efficiency to improve or worsen. Note that the (first) direction (increase or decrease) of the last-applied (first) control parameter modification is important at this stage because the (second) direction of the next subsequently applied (second) control parameter modification is the same as (equal to) the (first) direction when the comparison indicates an improvement in the BPED production efficiency. That is, when control passes along the path from block 251 to block 252+ to block 252+ to block 255+, and the associated comparison indicates that the second production efficiency value generated in block 253+ is greater than the first production efficiency value generated in block 251 (i.e., that the control parameter increase applied in block 252+ caused the BPED production efficiency to improve/increase), then control passes along the YES branch from block 255+ to block 252+, and the next subsequently applied (second) control parameter modification is applied in the increase direction. In contrast, when control passes along the path from block 251 to block 252− to block 252− to block 255−, and the associated comparison indicates that the second production efficiency value generated in block 253− is greater than the first production efficiency value generated in block 251 (i.e., that the control parameter decrease applied in block 252− caused the BPED production efficiency to improve/increase), then control passes along the YES branch from block 255− to block 252−, and the next subsequently applied (second) control parameter modification is also applied in the decrease direction.

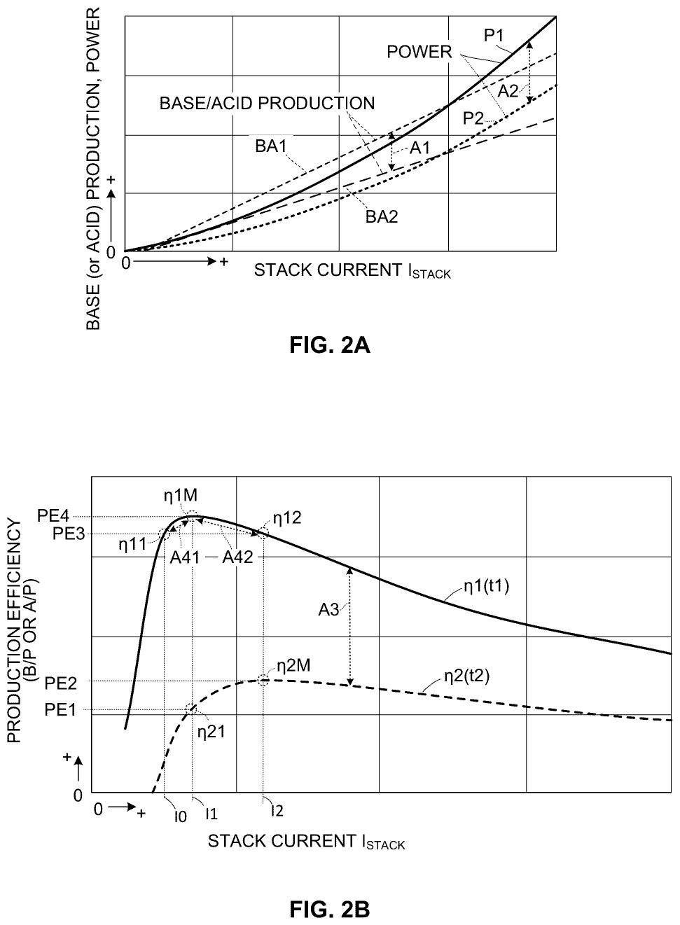

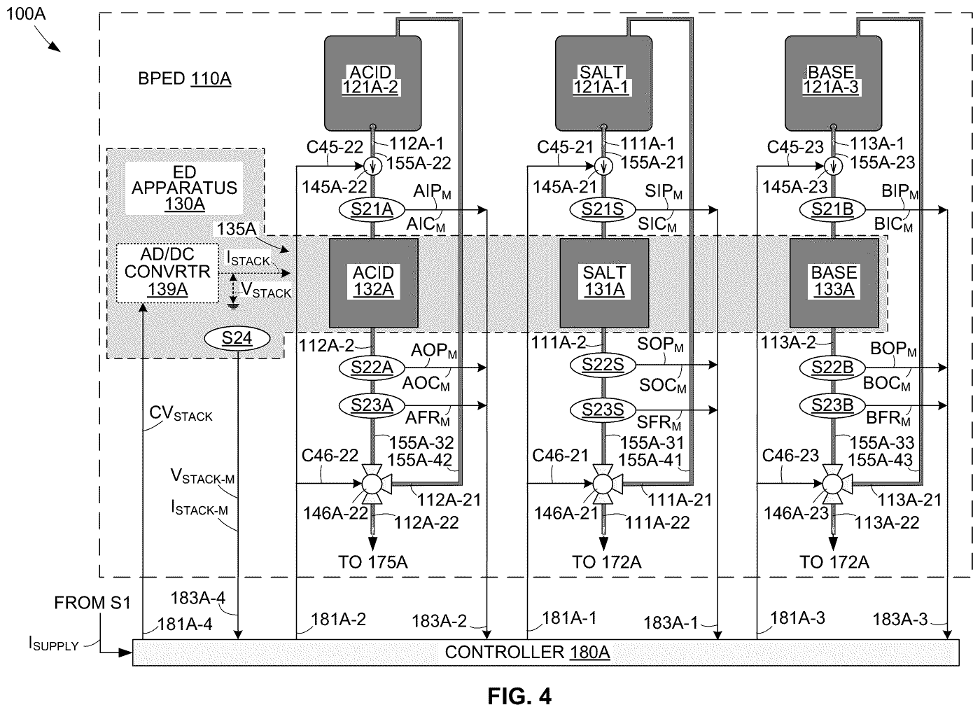

When the comparison of the first and second production efficiency values respectively generated in block 251 and block 253+ (or block 253−) fail to indicate that the first control parameter modification applied in block 252+ (or block 252−) caused a sufficient improvement in production efficiency, then control passes along the NO branch from block 255+ (or block 255−) to block 256+ (or block 256−). A second decision executed in block 256+ and 256− determines whether the difference between the first and second production efficiency values indicates either that the first control parameter modification applied in block 252+ (or block 252−) caused a worsening of the BPED production efficiency, or whether the difference indicates that a maximum production efficiency value has been reached. In one embodiment, a sufficiently large difference (i.e., greater than a predetermined minimum value) between the first and second production efficiency values is interpreted as a worsening of the BPED production efficiency, and control passes along the NO branch from block 256+ (or along the NO branch from block 256−). Note that control can only pass to block 256+ after a first control parameter modification is applied in the increase direction in block 252+, and control passes along the NO branch from block 256+ to block 252−, whereby the next sequential (second) control parameter modification is applied in the decrease direction (i.e., opposite to the first/increase direction). Similarly, control can only pass to block 256− after a first control parameter modification is applied in the decrease direction in block 252−, and control passes along the NO branch from block 256− to block 252+, whereby the next sequential (second) control parameter modification is applied in the increase direction (i.e., opposite to the first/decrease direction). That is, the second direction of the second modification is opposite to the first direction when the comparison indicates that applying the first modification caused the BPED production efficiency to decrease. When a maximum production efficiency value is detected (e.g., by way of detecting a sufficiently small or zero difference between the first and second production efficiency values), control passes along the YES branch from block 256+ (or block 256−) to a next operation, which may involve restarting process using the same control parameter or a different control parameter (e.g., as described below with reference to FIG. 4). The detection of maximum production efficiency values is described in additional detail below with reference to FIGS. 2A and 2B.

Production efficiency optimization process 250 implements a loop-type control path that repeats until a maximum production efficiency value is detected. That is, when the difference between the first and second (two preceding) production efficiency values indicates that the last-applied control parameter modification caused the BPED production efficiency to improve (increase) or worsen (decrease), control is passed back from one of block 255+, block 255−, block 256+ or block 256− to either block 252+ or 252−, whereby a second (next sequential) control parameter modification is applied in the manner described above, and then control is passed again to block 253+ or block 253− for the generation of a second production efficiency value. In this case (i.e., during the second and all subsequent loops until a maximum production efficiency value is detected), the second production efficiency value generated during the preceding loop is utilized as the first production efficiency value in the current loop (i.e., block 251 is bypassed). For example, assume first and second production efficiency values PEV1 and PEV2 are respectively generated by blocks 251 and 253+ during the application of a first control parameter modification, and assume value PEV2 is sufficiently greater than value PEV1 such that control is returned to block 252+ (i.e., from block 255+) and a second modification is applied to the selected control parameter. In this example, the subsequent decision as to whether the second control parameter modification improved or worsened the BPED production efficiency is determined by comparing the last two production efficiency values generated by block 253+ (i.e., production efficiency value PEV2 becomes the first production efficiency value, and a production efficiency value PEV3 generated by block 253+ after the second control parameter modification is applied becomes the second production efficiency value for purposes of determining the improvement/worsening caused by the second control parameter modification). This last-two-production-efficiency-values comparison is repeated during each subsequent loop to analyze the production efficiency increase/decrease caused by each subsequently applied control parameter modification, whereby production efficiency optimization process 250 biases each next subsequently applied control parameter modification in the direction (increase or decrease) that improves (increases) BPED production efficiency. For example, when the comparison performed in block 255+ during a given loop indicates that the previous control parameter modification applied in block 252+ resulted in an improved BPED production efficiency, control passes from block 255+ along the YES branch back to block 252+, whereby the next sequential control parameter is also modified in the increase direction. Conversely, when the comparison results indicates that the previous control parameter modification applied in block 252+decreased (worsened) BPED production efficiency, control is passed from block 256+ along the NO branch to block 252−, whereby the next sequential control parameter modification is applied in the decrease direction (i.e., opposite to the direction of the previous control parameter modification). Because sequentially applied control parameter modifications are biased in this way, control can pass from block 251 to either block 252+ or 252− during a first pass without significantly delaying the optimization process (i.e., because production efficiency optimization process 250 automatically reverses the increase/decrease direction of subsequently applied control parameter modifications whenever the first control parameter modification worsens BPED production efficiency).

A key motivation for utilizing production efficiency optimization process 250 to optimize the base (or acid) production efficiency of BPED 110 (i.e., when utilized in OAE system 100) is overall operating cost. That is, the OAE system's operating expense constitutes a major cost component of its associated LCOC, and the most significant expense associated with OAE system operation is the electrical expense (i.e., the ongoing cost of the externally supplied electricity needed to power an OAE system). Therefore, because the effectiveness of OAE systems as a NET is strongly dependent on minimizing LCOC, there is a strong motivation to optimize OAE system operations (and more specifically, BPED operations) in a way that maximizes base production efficiency. For similar reasons, when a BPED is utilized in an application in which the acid substance produced by the above-described electrochemical process is considered more valuable than the base substance, there is a strong motivation to optimize BPED operations in a way that maximizes acid production per unit of power consumption (i.e., to minimize the acid production cost). Because the same electrochemical process is utilized to generate both base substance (NaOH) and acid substance (HCl), production efficiency optimization process 250 may be utilized to control BPED operations such that either base production efficiency or acid production efficiency are optimized. Note that the Faradaic efficiency of IE stack 135 may be different for acid production than for base production at some operational times and conditions, but these differences may be accounted for by modifying/measuring different control parameters as described herein (e.g., by modifying/measuring base concentration when optimizing base production and modifying/measuring acid concentration when optimizing acid production). Therefore, although primarily described with reference to base production efficiency in the exemplary embodiments set forth below, production efficiency optimization process 250 is intended to also apply to acid production efficiency optimization unless otherwise specified in the appended claims.

FIGS. 2A and 2B are simplified graphs depicting BPED operating principles that were utilized in the development of production efficiency optimization process 250. Note that the graphs in FIGS. 2A and 2B are intended as generalized examples provided for descriptive purposes and are not intended to represent actual BPED operating data.

FIG. 2A is a simplified graph showing two exemplary changes in the rate of base or acid production (BASE/ACID PRODUCTION) and two exemplary changes in the rate of cell power consumption (POWER) as functions of stack current I_{STACK} for two different BPED operating states. The two exemplary base/acid production rate changes are indicated by dashed lines BA1 and BA2, and the two power consumption rate changes are indicated by solid line P1 and dotted line P2. The phrase “base/acid production rate” pertains to the rate at which either base substance or acid substance is produced in IE stack 135 by the electrochemical process described above (i.e., dashed lines BA1 and BA2 are representative of either base production or acid production). The phrases “change in base/acid production rate” and “change in power consumption rate” pertain to changes in production/consumption rate as a function of stack current.

Base/acid production lines BA1 and BA2 represent data modeled on observed changes in base production rate ΔBP as a function of stack current I_{STACK} using Equation 1 (below), where η represents the Faradaic efficiency of IE stack 135 when BPED 110 is in a given operating state, F is Faraday's constant, Q is the flow rate per cell of base solution stream (or acid solution stream) through an IE stack during base/acid production:

$$Δ BP = \frac{η {I}_{STACK}}{FQ} \qquad Equation 1$$

As explained below with reference to FIG. 2B, Faradaic efficiency η is a function of stack current, solution flow rate and inlet concentrations of all three salt/base/acid solution streams passing through the IE stack. For illustrative purposes Faradaic efficiency η is assumed to be relatively constant over the stack current range depicted in FIG. 2A (i.e., base/acid production lines BA1 and BA2 are depicted as being substantially linear compared to power lines P1 and P2 to emphasize the relatively small change in the base/acid production rate in comparison to the change in power consumption over the same range of stack current values).

During BPED operation, changes to the base/acid production rate are either relatively abrupt (e.g., caused by modifying one or more BPED control parameters) or relatively gradual (e.g., caused by gradual changes to one or more of the independent operating condition variables associated with Faradaic efficiency drift). The steeper slope of dashed line BA1 indicates a point in time when the change in base/acid production rate by BPED 110 is relatively high (e.g., when the salt/acid/base concentrations in the respective salt/acid/base solution streams are at relatively low first levels), and the shallower slope of dashed line BA2 indicates another point in time when the change in base/acid production rate by BPED 110 is relatively low (e.g., when at least one of the salt/acid/base concentration levels is/are higher than its corresponding first level). As indicated by arrow A1, an increase in one or more of the salt/acid/base concentrations can cause a decrease in the rate of base/acid production (e.g., the rate of base/acid production as a function of stack current shifts downward from line BA1 to line BA2). This increase can be implemented by increasing one or more of the salt/acid/base concentrations (e.g., by increasing an associated salt/acid/base recycle fraction in the manner described below with reference to FIG. 4, whereby the higher recycle fraction causes a corresponding higher IE stack inlet concentration, which in turn reduces the salt conversion rate and decreases Faradaic efficiency η). Conversely, a decrease in one or more of the salt/acid/base concentrations can cause an increase in the change of base/acid production rate (e.g., the rate of base/acid production as a function of stack current shifts upward from line BA2 to line BA1).

Power consumption lines P1 and P2 represent data modeled using Equation 2 (below), where V_{OCV} is open current voltage and is a function of fluid concentrations and membrane properties (which are constant in operation), and R is the area specific resistance (ASR) encountered by the stack current as it passes through the IE stack:

$$P = I V = {V}_{OCV} {I}_{STACK} + {{I}_{STACK}}^{2} R \qquad Equation 2$$

Note that power varies parabolically in response to changes to stack current for a given resistance value R according to the quadratic relationship of Equation 2 (i.e., power consumption lines P1 and P2 depict changes in power consumption rate associated with two different resistance values).

During BPED operation, changes to the power consumption rate can be caused by modifying one or more power-related BPED control parameters, or can be caused by gradual changes to one or more of the independent operating condition variables associated with Faradaic efficiency drift. For example, the power consumption rate decreases (i.e., shifts from line P1 to line P2, as indicated by arrow A2) in response to decreases in resistance R, and the power consumption rate increases (i.e., shifts from line P2 to line P1) when resistance R increases. During BPED operation, the value of resistance R typically gradually changes over time in response to process input and/or system dynamic changes, such as aging of the ion exchange membranes, scale build-up on the ion exchange membranes, changes in the flow rates of the three solution streams, and fluid property (e.g., conductivity) changes in the three solution streams.

FIG. 2B shows how the Faradaic efficiency of IE stack 135 determines changes in BPED production efficiency as a function of stack current I_{STACK} at two different points in time, where the Faradaic efficiency of IE stack 135 at the first point in time (t1) is indicated by solid line η1, and the Faradaic efficiency of IE stack 135 at the second point in time (t2) is indicated by dashed line η2. Faradaic efficiencies η1 and η2 are intended to be exemplary and generally illustrate how a BPED's production efficiency (e.g., either expressed in terms of B/P ratio or in terms of A/P ratio) may be limited at a given stack current by the BPED's Faradaic efficiency. As mentioned in the background section (above), Faradaic efficiencies η1 and η2 describe the efficiency with which charge is transferred within IE stack 135 at times t1 and t2, respectively, and determine the highest achievable base production efficiency at any given applied stack current level at time t1 and time t2. For example, if stack current I_{STACK} is applied at level I0 at time t1 while IE stack 135 operations are defined by Faradaic efficiency (solid line) η1 (e.g., when BPED 110 is in a first operating state), then BPED 110 produces base (or acid) at a production efficiency level PE3 (i.e., corresponding to point η11 on Faradaic efficiency curve η1). In contrast, if stack current I_{STACK} is applied at level I1 at time t1, then BPED 110 produces base (or acid) at a production efficiency level PE4 (i.e., corresponding to point η1M. In effect, the solid curved line indicating Faradaic efficiency η1 is formed by the locus of points (e.g., points η11, η1M and η12), where each point represents a production efficiency level as determined by Faradaic efficiency η1 as a function of stack current level. Note that the same range of stack currents produce different production efficiency levels when applied, while IE stack 135 operations are defined by Faradaic efficiency η2 (e.g., after BPED 110 has been switched into a different/second operating state, or after sufficient Faradaic efficiency drift has occurred). For example, if stack current I_{STACK} is applied at level I1 at time t2, then BPED 110 produces base (or acid) at a production efficiency level PE1 (i.e., corresponding to point η21 on Faradaic efficiency line η2), which is lower than the production efficiency level (i.e., PE4) generated in response to the same applied stack current level (i.e., I1) at time t1 (i.e., while IE stack 135 operations are defined by Faradaic efficiency η1).

At a given point in time, the Faradaic efficiency of IE stack 135 defines a single optimal production-efficiency-level/stack-current-level “point”. Referring to FIG. 2B, the generally upside-down-U-shape of the two curved lines representing Faradaic efficiencies η1 and η2 is attributable to a shunt current that increases resistance in IE stack 135 and is directly proportion to the applied stack current I_{STACK}. That is, when the level of applied stack current I_{STACK} is relatively low (e.g., near the left end of each curved line η1 and η2) the shunt current generated in IE stack 135 remains relatively low, whereby an increased production efficiency level can be achieved by increasing the level of applied stack current I_{STACK}. Conversely, at higher stack current levels, stack voltage V_{STACK} is correspondingly higher (e.g., near the right end of each curved line η1 and η2), which increases shunt current and thus decreases Faradaic efficiency, whereby increasing applied stack current I_{STACK} at these higher levels produces a decreased production efficiency level. The influence of shunt current on Faradaic efficiency is indicated by the generally upside-down-U-shape of Faradaic efficiencies η1 and η2, and produces a high point (apex) between the upward and downward sloping sections of each curved line η1 and η2 that represents a maximum (optimal) production efficiency that can be achieved by BPED 110 at times t1 and t2, respectively. That is, while IE stack 135 operations are defined by Faradaic efficiency η1, the base production efficiency of BPED 110 can be optimized at production efficiency level PE4 by applying a stack current level of I1 (i.e., corresponding to point η1M on Faradaic efficiency line η1). Similarly, while IE stack 135 operations are defined by Faradaic efficiency η2, the base production efficiency of BPED 110 can be optimized at production efficiency level PE2 by applying a stack current level of I2 (i.e., corresponding to point η2M on Faradaic efficiency line η2).

As mentioned in the background (above), Faradaic efficiency drift causes the Faradaic efficiency of IE stack 135 to change unpredictably over time, thereby causing an unpredictable change in the applied stack current needed to achieve the optimal production efficiency level at any given time. For example, as indicated by arrow A3, Faradaic efficiency drift can cause the Faradaic efficiency of IE stack 135 to change from Faradaic efficiency η1 at time t1 to Faradaic efficiency η2 at time t2, whereby the optimal production efficiency changes from point η1M at time t1 to point η2M at time t2. Assuming applied stack current I_{STACK} is at current level I1 at time t1 (i.e., to achieve optimal production efficiency point η1M at time t1) and is maintained at current level I1 from time t1 to time t2, the production efficiency of BPED 110 would gradually become more and more non-optimal as IE stack 135 changes from Faradaic efficiency η1 at time t1 to Faradaic efficiency η2 at time t2. That is, although applied stack current level I1 produces maximum production level η1M at time t1, the depicted Faradaic efficiency drift causes the optimal production efficiency level to move rightward along the stack current scale such that, at time t2, applied stack current level I1 produces a non-optimal production efficiency level PE1 (i.e., coinciding with point η21 on Faradaic efficiency η2), which is well below the optimal production efficiency level PE2 (i.e., coinciding with maximum point η2M on Faradaic efficiency η2). Note that the depicted rightward shift of optimal production efficiency (i.e., from maximum point η1M to maximum point η2M is provided for purposes of explanation, and that the actual shift caused by the Faradaic efficiency drift over a given time period may be entirely unpredictable. That is, as explained above, it is difficult (or impossible) to either measure or predict changes due to the large number of independent operating condition variables that are responsible for Faradaic efficiency drift). Therefore, it is not possible to predict the applied stack current changes that would be needed to achieve an optimal production efficiency level at any given time.

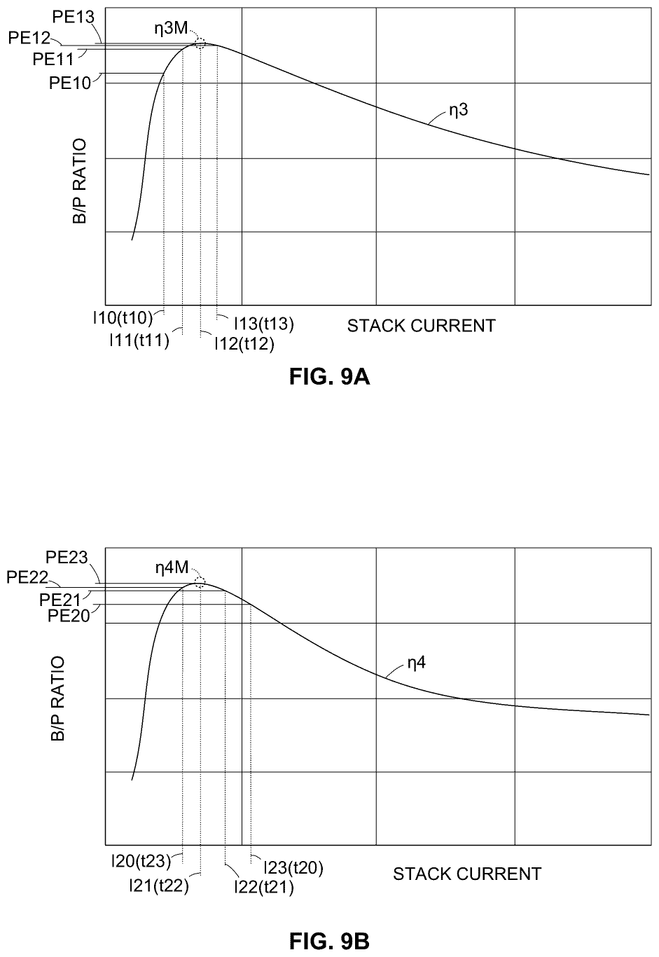

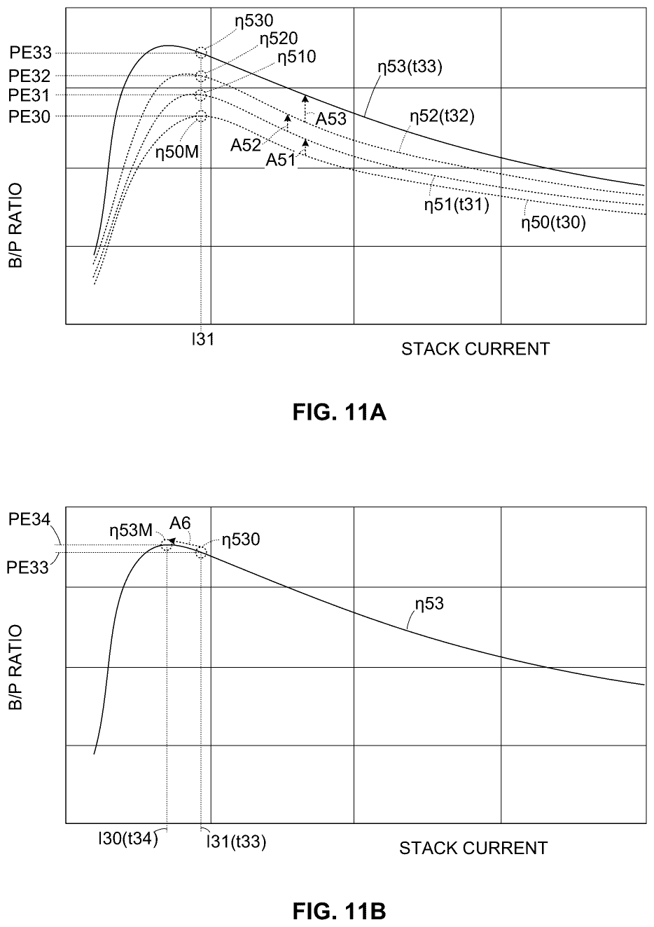

Production efficiency optimization process 250 circumvents the problems set forth above by effectively ignoring the independent operating condition variables causing Faradaic efficiency drift, and instead utilizes systematic control parameter modifications to both detect and compensate the changes in production efficiency that are caused by Faradaic efficiency drift. Each Faradaic efficiency (curved line) η1 and η2 represents a dividend of an associated pair of base/acid production lines (e.g., line B1) and power lines (e.g., line P1) described above with reference to FIG. 2A. As explained above, changes in the Faradaic efficiency of IE stack 135 are caused by Faradaic efficiency drift. In addition, changes in the Faradaic efficiency may also be achieved by way of changing (modifying) one or BPED control parameter settings associated with the base/acid production and power consumption of BPED 110 (i.e., by changing one or BPED control parameter settings in a way increases the slopes of one or both of the acid/base production or power lines depicted in FIG. 2A, for example, such that base/acid production changes from line BA2 to line BA1 and/or such that power consumption changes from line P2 to line P1). As set forth below, production efficiency optimization process 250 facilitates changes in production efficiency that minimally affect the Faradaic efficiency of IE stack 135 by way of changing the applied stack current level (e.g., as indicated by arrows A41 and A42 in FIG. 2B, by effectively moving along Faradaic efficiency line η1 without significantly affecting the shape of Faradaic efficiency line η1). As explained below with reference to FIGS. 9A and 9B, systematic modification of the applied stack current level is utilized to both “fine-tune” the optimization results achieved by production efficiency optimization process 250 and to identify maximum production efficiency values. In addition, production efficiency optimization process 250 facilitates more significant changes in the Faradaic efficiency of IE stack 135 by way of changing salt/acid/base concentrations and/or salt/acid/base flow rates (e.g., as indicated by arrow A3, these changes may be used to shift the Faradaic efficiency of IE stack 135 from Faradaic efficiency η2 to Faradaic efficiency η1. As explained below with reference to FIGS. 11A and 11B, systematic modification of these control parameters facilitates achieving higher production efficiency levels than could be achieved by way of utilizing only systematic applied stack current level modifications.

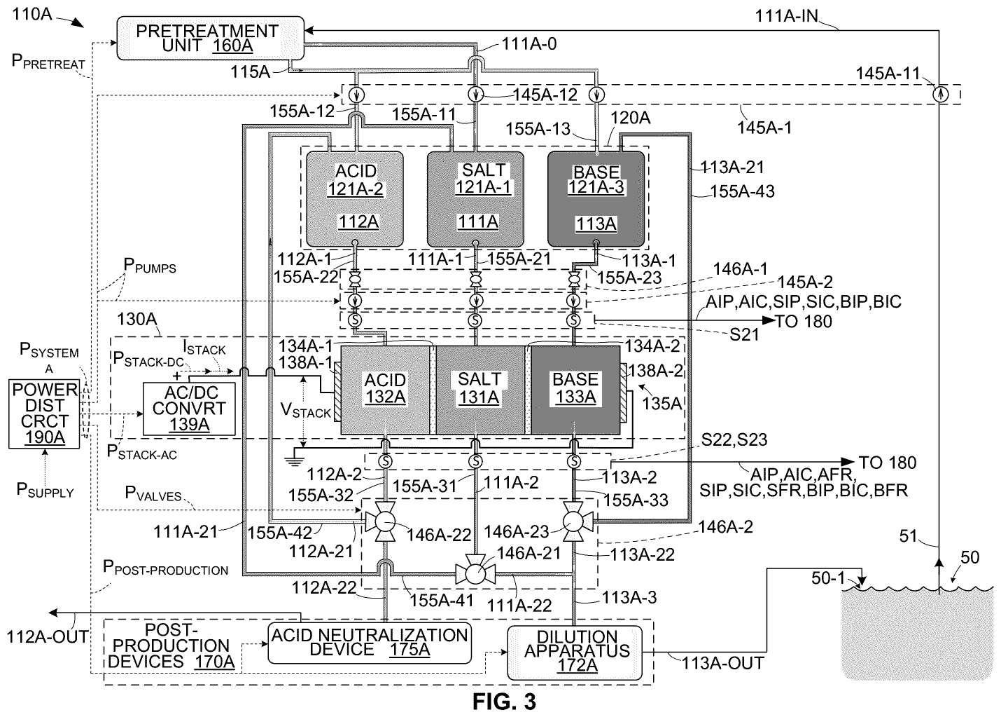

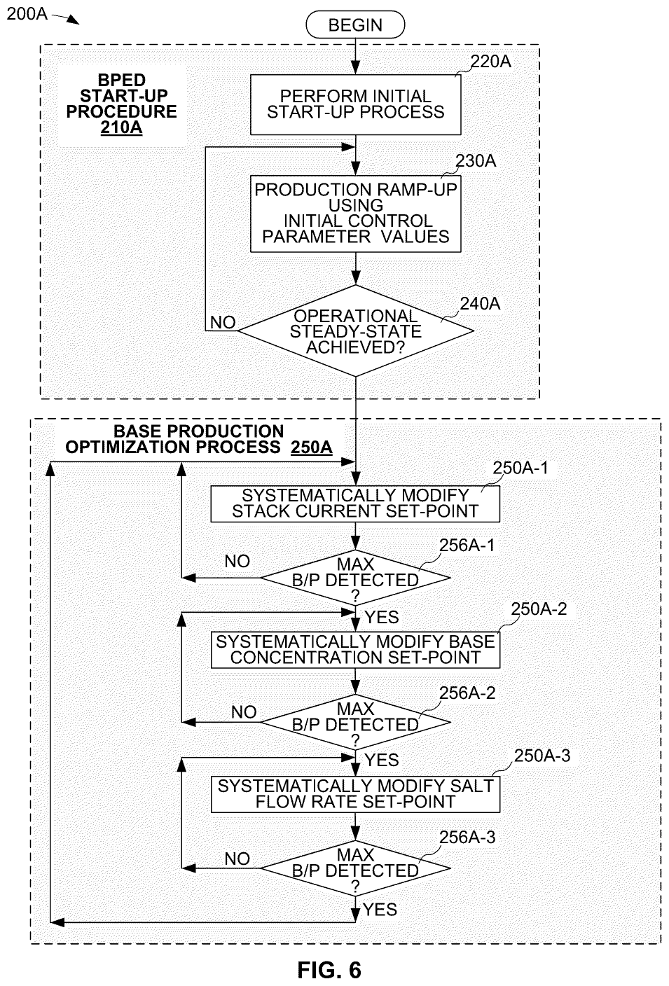

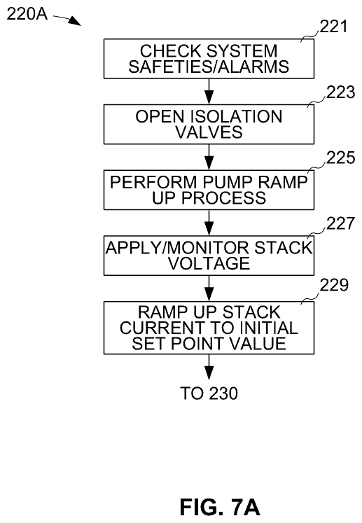

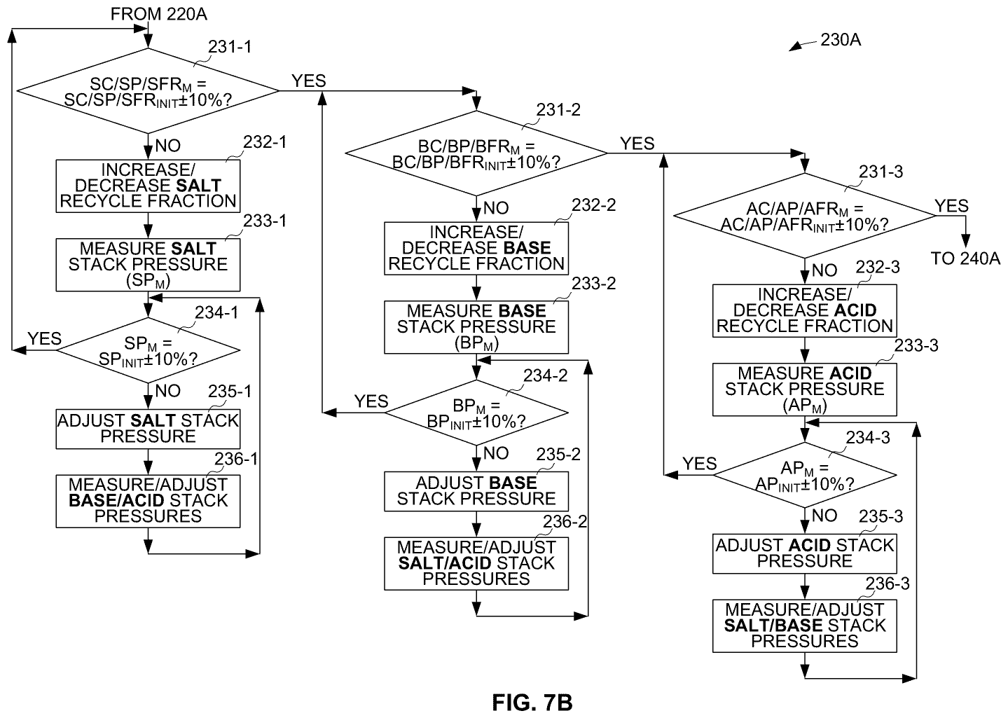

The present invention will now be described in additional detail with reference to optimizing the production efficiency of a BPED 110A (i.e., a BPED having the features described below with reference to FIGS. 3-5) using BPED operating method 200A, which is generally described with reference to FIG. 6 and described in additional detail in FIGS. 7 to 12.

Referring to FIG. 3, BPED 110A includes a fluid storage system 120A, an electrodialysis apparatus 130A, and a flow control system comprising the various pumps, valves and a series of flow lines referenced below. BPED 110A processes salt to generate both an acid substance and a base substance using the electrochemical process described above with reference to FIG. 1. As indicated in FIG. 3, BPED 110A may be utilized in an OAE system (e.g., OAE system 100 described above with reference to FIG. 1), wherein the base substance generated by BPED 110A is used to generate an ocean alkalinity product 113A-OUT to ocean 50. In other embodiments (not shown), BPED 110A may be utilized in another system in which the base substance and/or acid substance are utilized for other purposes (e.g., wherein an acid product 112A-OUT is utilized to produce hydrogen, oxygen or chlorine gas for commercial purposes, or utilized to generate carbon-free energy). In either case, operations performed by BPED 110A may be controlled in accordance with the methods described herein.

Referring to the upper portion of FIG. 3, fluid storage system 120A can include at least three main holding tanks: a salt (first) holding tank 121A-1 utilized to receive and store (buffer) a quantity of feedstock (salt) solution 111A, an acid (second) holding tank 121A-2 utilized to store a quantity of acid solution 112A, and a base (third) holding tank 121A-3 utilized to store a quantity of base solution 113A. In an embodiment, each holding tank 121A-1 to 121A-3 can be implemented using a standard 1000L IBC caged tote tank, where each holding tank 121A-1 to 121A-3 includes an associated inflow port and an associated outflow port. In other embodiments (not shown), fluid storage system 120A may be modified to include one or more additional holding tanks that may be utilized to store, for example, fresh or deionized water or intermediate solutions utilized by BPED 110A. In some embodiments additional holding tanks may be utilized to store quantities of previously generated base substance and acid substance solutions, thereby allowing the control algorithm to decouple the best time to generate acid and base substances (e.g., when electricity carbon intensity and price are most favorable) from the best time to supply ocean alkalinity product 113A-OUT to ocean 50 (i.e., as determined at least partially by data from ocean-based seawater chemistry sensors located adjacent to outfall location 50-1).

In some embodiments BPED 110A includes a pretreatment unit 160A connected between the conduit supplying feedstock solution 111A-IN (e.g., seawater 51 from ocean 50 or brine from another feedstock source) and fluid storage system 120A. Pretreatment unit 160A receives and processes feedstock solution 111A-IN and is configured to generate both a reduced-salt fluid 115A (e.g., permeate having essentially 0% salt) and a high-salt fluid 111A-0 (concentrate having approximately 7% salt), whereby high-salt fluid 111A-0 has a higher salt concentration than both seawater 51 and reduced-salt fluid 115A. As discussed below, high-salt fluid 111A-0 is directed to first (salt) holding tank 121A-1 and reduced-salt fluid 115A is directed to second (acid) holding tank 121A-2 and the third (base) holding tank 121A-3 to replace the outflow volumes represented by salt product fraction 111A-22, acid product fraction 112A-22 and base product fraction 113A-22. In an exemplary embodiment pretreatment unit 160A may be implemented by a commercially available reverse osmosis system.

Electrodialysis apparatus 130A includes an AC/DC converter (stack current generator) 139A configured to generate a stack voltage V_{STACK} across electrodes 138A-1 and 138A-2, thereby generating a stack current I_{STACK} passing through an IE stack 135A sandwiched between electrodes 138A-1 and 138A-2. As described above with reference to FIG. 1, IE stack 135A generally includes at least one cell formed by a salt chamber 131A disposed between an acid chamber 132A and a base chamber 133A and separated by ion exchange membranes 134A-1 and 134A-2. IE stack 135A may include multiple cells disposed in a repeating series arrangement, where salt, acid and base solution streams are split into associated sub-streams by an input manifold and passed through the salt, acid and base chamber of each cell, for example, using the arrangement described with reference to FIG. 4 of patent application Ser. No. 17/838,967 (cited above). During operation, stack current I_{STACK} passes through all of the multiple cells to electrochemically process NaCl (salt) atoms provided in each of the salt sub-streams, thereby enhancing (i.e., decreasing the pH of) an adjacent acid solution sub-stream and enhancing (i.e., increase the pH of) an adjacent base solution sub-stream. In one embodiment, AC/DC converter 139A is configured to convert AC stack power P_{STACK-AC} into direct current (DC) stack power P_{STACK-DC}, and AC/DC converter 139A is configured to control the amount (level) of both DC stack voltage V_{STACK} and DC stack current I_{STACK} supplied to IE stack 135A in response to control signals (not shown) received from control circuit 180. In other embodiments AC/DC converter 139A may be replaced with another circuit capable of generating I_{STACK} at a current level (amount) determined by an applied control signal.

In one embodiment, the flow control system of BPED 110A comprises various control elements (e.g., pumps and valves) that are collectively configured to direct streams of the various solutions (and other fluids) by way of associated conduits (flow lines) in the manner depicted in FIG. 3. For example, a set of input pumps 145A-1 (indicated by circled arrows pointing along the associated flow direction) includes a first feedstock pump 145A-11 that supplies feedstock solution 111A-IN by way of an input conduit to a pretreatment unit 160A, a second pump 145A-12 that supplies concentrate 111A-0 by way of a conduit 155A-11 to holding tank 121A-1, and one or more additional pumps that supply permeate 115A to holding tanks 121A-2 and 121A-3 by way of conduits 155A-12 and 155A-13, respectively. A set of isolation valves 146A-1 are operably connected in conduits 155A-21 and 155A-23 between isolation valves 146A-1 and IE stack 130A, and are controlled by way of associated control signals (e.g., generated by controller 180, FIG. 1) to open or close the flow of strong salt stream 111A-1 from holding tank 121A-1 to salt chamber 131A by way of conduit 155A-21, the flow of weak acid solution 112A-1 from holding tank 121A-2 to base chamber 132A by way of conduit 155A-22, and the flow of weak base solution 113A-1 from holding tank 121A-3 to base chamber 133A by way of conduit 155A-23. A set of pressure control pumps 145A-2 are operably connected in conduits 155A-21 and 155A-23 between isolation valves 146A-1 and IE stack 130A and are respectively configured to supply strong salt solution 111A-1, weak acid solution 112A-1 and weak base solution 113A-1 to IE stack 130A at flow rates and pressures determined by associated control signals in the manner described below. In some embodiments, BPED 110A is operated in a “feed and bleed” mode wherein product fractions (sub-streams) of depleted salt stream 111A-2, strong acid stream 112A-2 and strong base stream 113A-2 are bled off (diverted) for use in the generation of alkalinity product 113A-OUT or other purposes. Referring to the lower portion of FIG. 3, output fraction control valves 146A-2 are configured to facilitate feed-and-bleed operations by dividing the three streams leaving IE stack 130A into corresponding recycle and product fractions (sub-streams). Output fraction control valve 146A-21 divides depleted salt stream 111A-2 into a salt recycle fraction 111A-21 and a salt product fraction 111A-22, where salt recycle fraction 111A-21 is directed back to salt holding tank 121A-1 by way of a conduit 155A-41, and salt product fraction 111A-22 is directed to a dilution apparatus 172A (described below). Output fraction control valve 146A-22 divides strong acid stream 112A-2 into an acid recycle fraction 112A-21 and an acid product fraction 112A-22, where acid recycle fraction 112A-21 is directed back to acid holding tank 121A-2 by way of conduit 155A-42, and acid product fraction 112A-22 is directed to an acid neutralization device 175A. Output fraction control valve 146A-23 divides strong base stream 113A-2 into a base recycle fraction 113A-21 and a base product fraction 113A-22, where base recycle fraction 113A-21 is directed back to base holding tank 121A-3 by way of conduit 155A-43, and base product fraction 113A-22 is directed to dilution apparatus 172A. Each fraction control valve 146A-21, 146A-22 and 146A-23 is separately controlled by one or more control signals in the manner, whereby, during enabled (feed-and-bleed) operating modes, control circuit 180 independently controls the volumes (amounts) of each recycle fraction 111A-21, 112A-21 and 113A-21 returned to the holding tanks, and the volumes (amounts) of each product fraction 111A-22, 112A-22 and 113A-22 that is “bled out”. In the depicted embodiment, salt product fraction 111A-22 and base product fraction 113A-22 are mixed to form a base/salt product 113A-3 before being utilized to generate ocean alkalinity product 113A-OUT. In other embodiments these product fractions can be transmitted separately to dilution apparatus 172A.

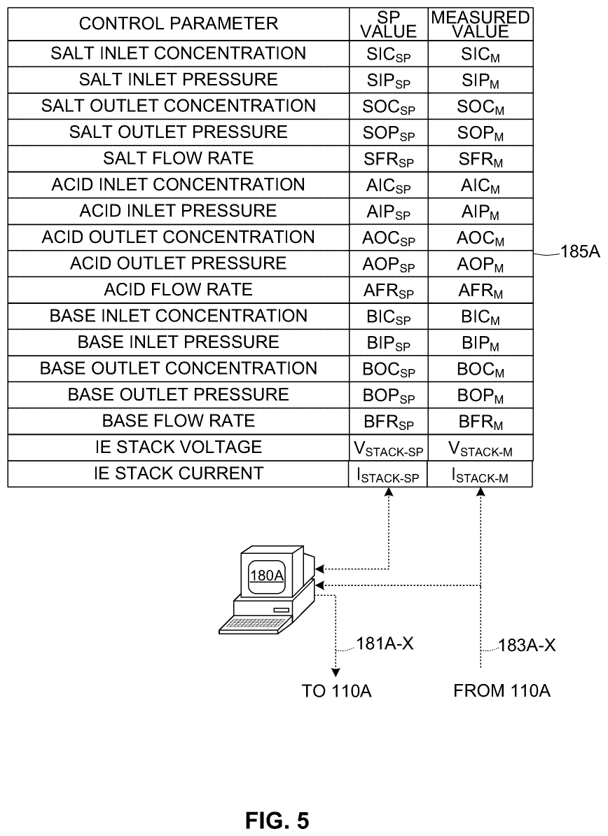

BPED 110A includes sensor sets S21, S22 and S23 that are operably disposed to collect data from the various solution streams and to transmit the collected data in real time to controller 180 in the manner mentioned above with reference to FIG. 1. The general location of at least some of the sensors in each set is indicated in FIG. 3 using circled-S symbols, and additional information regarding these sensors is provided below with reference to FIG. 5. In one embodiment, an input sensor set S21 includes sensors configured to measure pressure and composition/concentration from the solution streams flowing in conduits 155A-21, 155A-22 and 155A-23 between isolation valves 146A-1 and IE stack 130A. That is, each sensor of input sensor set S21 is configured to measure the pressure and salt/acid/base concentrations in strong salt stream 111A-1, weak acid stream 112A-1 and weak base stream 113A-1 that are respectively flowing in conduits 155A-31, 155A-32 and 155A-33, and configured to generate associated pressure and composition/concentration data including a salt input pressure value SIP, a salt input composition/concentration value SIC, an acid input pressure value AIP, an acid input composition/concentration value AIC, a base input pressure value BIP and a base input composition/concentration value BIC. Similarly, a set of output sensors S22 and a set of flow rate sensors S23 include sensors configured to measure pressure, composition/concentration and flow rate from the weak (depleted) salt solution stream 111A-2, the strong acid solution stream 112A-2 and the strong base stream 113A-2 flowing from IE stack 135A along conduits 155A-31, 155A-32 and 155A-33, respectively. That is, output sensor set S21 is configured to measure salt/acid/base solution pressure and salt/acid/base concentrations on the downstream side of IE stack 135A, and configured to generate associated data including a salt output pressure value SOP, a salt output composition/concentration value SOC, an acid output pressure value AOP, an acid output composition/concentration value AOC, a base output pressure value BOP and a base output composition/concentration value BOC. Flow rate sensors S23 are configured to measure the flow rate of the salt/acid/base solution streams passing through IE stack 135A. As indicated, all sensor values generated by input sensor set S21, output sensor set S22 and flow rate sensor set S23 are transmitted to controller 180. Note that flow control sensor set S23 may be located upstream of IE stack 135A.

Referring to the bottom of FIG. 3, in one embodiment post-production devices 170 include a dilution apparatus 170A and an acid neutralization device 175A.

Dilution apparatus 172A can be configured to generate ocean alkalinity product 113A-OUT by processing and testing base/salt product 113A-3. As mentioned above, to avoid endangering sea life, and to maximize the potential benefits to sea life, ocean alkalinity product 113A-OUT can be a well characterized solution including a mixture of the base substance and saltwater that is released (supplied to ocean 50) only after verifying that the base substance is fully dissolved in the solution, and that the mixture has an appropriate pH value. To this end, dilution apparatus 172A can function to both verify and, if necessary, perform post-processing of the base/salt product solution generated by BPED 110A before releasing the verified/processed base solution as ocean alkalinity product 113A-OUT. In one embodiment this processing may include reacting base/salt product 113A-3 with air or CO₂ and/or diluted with seawater or another saltwater solution to generate ocean alkalinity product 113A-OUT with a target pH range. In one embodiment, at least a portion of contaminants removed from seawater 111A-IN by pretreatment apparatus 160A may be supplied to dilution apparatus 172A for addition to ocean alkalinity product 113A-OUT.

Acid neutralization device 175A receives and processes acid product fraction 112A-22 for power generation or commercial purposes. In one embodiment, device 175A is an electrolyzer configured to generate hydrogen gas H₂ that can be processed by a fuel cell (not shown) to generate supplemental low/zero-carbon electricity to further enhance the economically sustainability of a OAE system 100A as a carbon offset system (e.g., by way of transmitting the supplemental electricity to power distribution circuit 190A to reduce the amount of external power consumed by BPED 110A). In some embodiments, acid neutralization device 175A can be configured to produce one or more additional gasses, such as chlorine gas Cl₂ and/or oxygen gas O₂, that may be sold to further enhance the economically sustainability of OAE system 100A as a carbon offset system. It may be desirable to treat acid product fraction 112A-22 before undergoing the acid neutralization process. Some possible methods of pretreatment, not pictured, may include filtration, chemical, electrochemical, nanofiltration, ultrafiltration, reverse osmosis, heating, and cooling. In other embodiments, not pictured, acid product fraction 112A-22 can be utilized in a flow battery to produce supplemental low/zero-carbon electricity to help offset input power.

Referring to the left side of FIG. 3, in one embodiment power distribution circuit 190A receives and (if necessary) converts externally supplied power P_{SUPPLY} to generate system power P_{SYSTEMA} at appropriate voltage/current levels, and then distributes system power P_{SYSTEMA} to the various devices of BPED device 110A as indicated by dashed line arrows. For example, a first portion P_{PRETREAT} of system power P_{SYSTEMA} may be supplied to pretreatment unit 160A at a voltage and current level that is suitable for operating pretreatment unit 160A. Similarly, a second portion P_{PUMPS} may be supplied to the various pumps utilized to generate the streams describe above, a third portion P_{VALVES} may be supplied to the various control valves utilized to control and divide the streams, a fourth portion P_{POST-PRODUCTION} may be supplied to post-production devices such as dilution apparatus 172A and acid neutralization device 175A, and a fifth portion including AC stack power P_{STACK-AC} that is supplied to ED stack 135A.

FIG. 4 shows a simplified system 100A including BPED 110A (described above) and a controller 180A that is configured to perform BPED control method 200A, which is described below with reference to FIG. 6. System 100A may be an OAE system, such as OAE system 100 described above with reference to FIG. 1, or another type of system that utilizes BPED 110A to produce base substance and/or acid substance. Note that FIG. 4 only depicts portions of BPED 110A that are relevant to BPED control method 200A, and that the depicted portions are arranged in a functional manner for descriptive purposes. For example, ED apparatus 130A is depicted in a simplified manner generally indicating the function of AC/DC converter (stack current generator) 139A to generate and supply stack current I_{STACK} to IE stack 135A in the manner described above with reference to FIG. 3, and IE stack 135A is functionally indicated by salt chamber 131A, acid chamber 132A and base chamber 133A in a spaced-apart arrangement to clarify the separate operations of the flow control and sensor devices related to each of the three (i.e., salt, acid and base) solution streams. The depicted control lines are exemplary and the depicted sensors and valves may not be addressed from the same control line.

Referring to the center-right portion of FIG. 4, salt holding tank 121A-1 supplies strong salt stream 111A-1 to salt chamber 131A by way of pressure control pump 145A-21 and salt inflow conduit 155A-21, and weak salt stream 111A-2 exits salt chamber 131A by way of salt outflow conduit 155A-31 and is divided by output fraction control valve 146A-21 into a salt recycle fraction 111A-21, which is returned to salt holding tank 121A-1 by way of salt recycle conduit 155A-41, and a salt product fraction 111A-22, which is supplied to dilution apparatus 172A (described above). Referring to the center-left portion of FIG. 4, acid holding tank 121A-2 supplies weak acid stream 112A-1 to acid chamber 132A by way of pressure control pump 145A-22 and acid inflow conduit 155A-22, and strong acid stream 112A-2 exits acid chamber 132A by way of acid outflow conduit 155A-32 and is divided by output fraction control valve 146A-22 into an acid recycle fraction 112A-21, which is returned to acid holding tank 121A-2 by way of acid recycle conduit 155A-42, and an acid product fraction 112A-22, which is supplied to acid neutralization device 175A. Referring to the right side of FIG. 4, base holding tank 121A-3 supplies weak base stream 113A-1 to base chamber 133A by way of pressure control pump 145A-23 and base inflow conduit 155A-23, and strong base stream 113A-2 exits base chamber 133A by way of base outflow conduit 155A-33 and is divided by output fraction control valve 146A-23 into a base recycle fraction 113A-21, which is returned to base holding tank 121A-3 by way of base recycle conduit 155A-43, and a base product fraction 113A-22, which is supplied to dilution apparatus 172A.

Referring to the lower portion of FIG. 4, controller 180A controls the operations of BPED 110A by way of transmitting control signals on control signal lines 181A-1 to 181A-4 to associated BPED control devices. Referring to the center-right portion of FIG. 4, controller 180A controls the flow rate and inflow pressure of strong salt stream 111A-1 by way of a pump control signal C45-21 transmitted on control signal line 181A-1 to pressure control pump 145A-21, and controls the amount of weak salt stream 111A-2 returned to salt holding tank 121A-1 by way of a valve control signal C46-21 transmitted on control signal line 181A-1 to salt recycle valve 146A-21. Referring to the center-left portion of FIG. 4, controller 180A controls the flow rate and inflow pressure of weak acid stream 112A-1 by way of a pump control signal C45-22 transmitted on control signal line 181A-2 to pressure control pump 145A-22, and controller 180A controls the amount of strong acid stream 112A-2 returned to acid holding tank 121A-2 by way of a valve control signal C46-22 transmitted on control signal line 181A-2 to acid recycle valve 146A-22. Referring to the right side of FIG. 4, controller 180A controls the flow rate and inflow pressure of weak base stream 113A-1 by way of a pump control signal C45-23 transmitted on control signal line 181A-3 to pressure control pump 145A-22, and controller 180A controls the amount of strong base stream 113A-2 returned to base holding tank 121A-3 by way of a valve control signal C46-23 transmitted on control signal line 181A-3 to base recycle valve 146A-23. Referring to the left side of FIG. 4, controller 180A also controls the magnitude of stack current I_{STACK} generated by AC/DC converter 139A by way of a voltage control signal CV_{STACK} transmitted on control signal line 181A-4.

Controller 180A also controls the operations of BPED 110A using sensor (feedback) data received on sensor signal lines 183A-1 to 183A-4 from various sensors disposed in the salt, acid and base solution steams. Referring to the center-right portion of FIG. 4, controller 180A monitors salt solution inflow pressure and inflow concentration by way of measurement data SIP_{M} and SIC_{M} collected by one or more sensors S21S from salt inflow conduit 155A-21, monitors salt solution outflow pressure and outflow concentration by way of measurement data SOP_{M} and SOC_{M} collected by one or more sensors S22S from salt outflow conduit 155A-22, and monitors salt solution flow rate using measurement data SFR_{M} collected by sensor S23S from salt outflow conduit 155A-31, where salt measurement data SIP_{M}, SIC_{M}, SIP_{M}, SIC_{M} and SFR_{M} is transmitted on sensor signal lines 183A-1 to controller 180A. Referring to the center-left portion of FIG. 4, controller 180A monitors acid solution inflow pressure and inflow concentration by way of measurement data AIP_{M} and AIC_{M} collected by one or more sensors S21A from acid inflow conduit 155A-22, monitors acid solution outflow pressure and outflow concentration by way of measurement data AOP_{M} and AOC_{M} collected by one or more sensors S22A from acid outflow conduit 155A-32, and monitors acid solution flow rate using measurement data AFR_{M} collected by sensor S23S from acid outflow conduit 155A-32, where acid measurement data AIP_{M}, AIC_{M}, AIP_{M}, AIC_{M} and AFR_{M} is transmitted on sensor signal lines 183A-2 to controller 180A. Referring to the right side of FIG. 4, controller 180A monitors base solution inflow pressure and inflow concentration by way of measurement data BIP_{M} and BIC_{M} collected by one or more sensors S21B from base inflow conduit 155A-23, monitors base solution outflow pressure and outflow concentration by way of measurement data BOP_{M} and BOC_{M} collected by one or more sensors S22B from base outflow conduit 155A-33, and monitors base solution flow rate using measurement data BFR_{M} collected by sensor S23B from base outflow conduit 155A-33, where base measurement data BIP_{M}, BIC_{M}, BIP_{M}, BIC_{M} and BFR_{M} is transmitted on sensor signal lines 183A-3 to controller 180A. Controller 180A also monitors the stack voltage V_{STACK} and/or stack current I_{STACK} generated by AC/DC converter 139A by way of associated measurement data V_{STACK-M} and I_{STACK-M} collected by a monitor/sensor S24A and transmitted on sensor signal lines 183A-4.

Referring to the lower left corner of FIG. 4, controller 180A also receives system power data from a suitable source, such as supply current data I_{SUPPLY} from sensor S1 as described above with reference to FIG. 1. The various controls and sensor data collected by controller 180A are described in the examples set forth below.

FIG. 5 depicts computer memory 185A that is operably configured to receive and store set-point values and sensor data utilized by controller 180A during the execution of BPED control method 200A (as described below with reference to FIG. 6). Computer memory 185A may be integral to controller 180A or part of an external storage device. For descriptive purposes, computer memory 185A includes a set-point value and a measured value for each control parameter, where each set-point value (identified by the suffix “SP”) is generated by controller 180A in accordance with BPED control method 200A (as described below), and each measured value (identified by the suffix “M”) represents a most-recently-measured value read by an associated sensor and transmitted on an associated sensor signal line 183A-X in the manner described above with reference to FIG. 4. As set forth below, controller 180A utilizes the stored data to generate the various BPED control signals that are transmitted on control signals lines 181A-X to corresponding control devices of BPED 110A during the execution of BPED control method 200A.

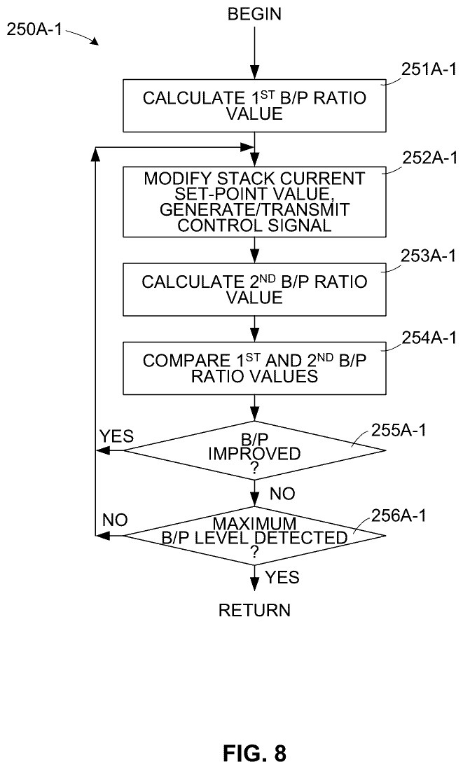

Referring to FIG. 6, BPED operating method 200A generally includes a start-up procedure 210A and a base production optimization process 250A. Start-up process 210A uses an initial start-up process (block 220A) to initiate operations of BPED 110A from an idle (i.e., fully stopped or non-production) operating state, and then controls acid/base production operations of BPED 110A using a predetermined group of initial control parameter set-point values (block 230A) until an operation steady-state is achieved (block 240A). Initial start-up process 220A and acid/base production ramp-up process 230A are described in additional detail below with reference to FIGS. 7A and 7B. Production efficiency optimization process 250A is executed after BPED 110A achieves operational steady-state and involves systematically modifying a stack current set-point value (block 250A-1) during a first time period that ends when a first maximum production efficiency value is detected (block 256A-1), then systematically modifying a base concentration set-point value (block 250A-2) during a second time period that ends when a second maximum production efficiency value is detected (block 256A-2), then systematically modifying a salt solution flow rate set-point value (block 250A-3) during a third time period that ends when a third maximum production efficiency value is detected (block 256A-3). The systematic modifications of stack current (block 250A-1), base concentration (block 250A-2) and salt solution flow rate (block 250A-3) are described in additional detail below with reference to FIGS. 8 through 12. After the third maximum production efficiency value is detected (i.e., after the third time period), control passes along the YES branch from block 256A-3 to block 250A-1, whereby the sequence of systematic modifications of the stack current set-point value (block 250A-1), the base concentration set-point value (block 250A-2) and the salt solution flow rate set-point value (block 250A-3) is repeated in a continuous loop during BPED operations. Although described with reference to the systematic modification of three BPED control parameters, production efficiency optimization process 250A may be implemented with the systematic modification of any number of BPED control parameters. Moreover, although described with reference to systematically modifying a set of selected BPED control parameters in a repeating sequential order, production efficiency optimization process 250A may be modified to systematically modify a set of selected BPED control parameters in any order or in a randomly selected manner.

FIG. 7A depicts initial start-up process 220A of BPED start-up procedure 210A (FIG. 6) in additional detail and is described with reference to relevant structures of BPED 110A (FIGS. 3 and 4). In one embodiment, initial start-up process 220A is performed each time system 100A switches from an idle (e.g., non-base-producing) operating mode into a base producing (e.g., “feed and bleed”) operating mode. Start-up process 220A begins by checking system safeties and alarms (block 221) to verify that BPED 110A can be operated safely (e.g., by monitoring the sensor data provided on sensor signal lines 183A-1 to 183A-4, described above, and/or other signals generated by safety anomaly sensors or other sources), and terminates the start-up process if any of these safeties/alarms indicate a problem. Next, isolation valves 146A-1 are opened (block 223) to facilitate flow between holding tanks 121A-1 to 121A-3 and IE stack 135A. A pump ramp-up process (block 225) is then performed to initiate flows of fluids from holding tanks 121A-1 to 121A-3 to IE stack 135A by way of pressure control pumps 145A-1. In one embodiment, the pump ramp-up process involves checking and balancing strong salt stream 111A-1, weak acid stream 112A-1 and weak base stream 113A-1 to maintain suitable cross-pressures within IE stack 135A. Stack voltage V_{STACK} is then applied across IE stack 135A (block 227) according to a predetermined initial set-point value and monitored to assure that a minimum threshold is reached to perform the electrochemical process. Stack current I_{STACK} is then incrementally ramped up (block 229) using known techniques until stack current I_{STACK} passing through IE stack 130 is substantially equal to (i.e., within 10% of) a predetermined initial stack current set-point value I_{STACK-SP}. The above-described initial start-up process is intended to be exemplary and may be modified without detracting from the spirit and scope of the invention.

Referring again to FIG. 6, acid/base production ramp-up process 230A is executed after completing initial start-up process 220A. Acid/base production ramp-up process 230A generally involves utilizing a predetermined set of initial control parameter values to control BPED operations until acid/base production by BPED 110A achieves an acceptably steady state. The initial control parameter values are intended to establish baseline BPED operations and are determined using known techniques (e.g., using machine learning, or by observations of previous BPED operations). Referring to memory 185A in FIG. 5, in an embodiment an associated initial set-point value is written into the set-point value (SP VALUE) memory location for each of the listed control parameters at some point before the end of initial start-up process 220A. During acid/base production ramp-up process 230A the initial control parameter set-point values are utilized to control the various BPED control devices (e.g., the pumps and valves described above with reference to FIG. 4) in accordance with corresponding measured control parameter values, which are periodically generated for each control parameter using the various sensors described above with reference to FIG. 4. That is, control signals sent to the various BPED control devices are generated in accordance with a comparison between the most recently measured value for each control parameter and its corresponding initial set-point value. For example, referring to FIG. 5, when the most-recent measured salt inlet concentration control parameter value SIC_{M} is less than the initial set-point value stored in memory location SIC_{SP}, control signal C46-21 is generated with a value that causes salt recycle valve 146A-21 to increase the salt recycle fraction 111A-21 returned to salt holding tank 121A-1, thereby causing an increase in the concentration of salt in strong salt stream 111A-1. In an embodiment, acid/base production ramp-up process 230A is completed (i.e., steady-state operation is achieved) when each measured control parameter value is sufficiently equal to (e.g., within 10% of) its corresponding initial set-point value, whereby control passes along the YES branch from block 240A to begin production efficiency optimization process 250A.

FIG. 7B depicts acid/base production ramp-up process 230A according to an embodiment in which the BPED control devices are controlled in three operating phases, where the first phase involves achieving steady-state of BPED operations related to the salt solution stream, the second phase involves achieving steady-state of BPED operations related to the base solution stream, and the third phase involves achieving steady-state of BPED operations related to the acid solution stream.

Referring to decision block 231-1 in the upper left portion FIG. 7B, the first phase is performed until measured salt-related control parameter values (e.g., SIC_{M}, SOC_{M}, SIP_{M}, SOP_{M} and SFR_{M} ) are respectively substantially equal to corresponding initial salt-related control parameter set-point values (e.g., SIC_{M}=SIC_{INIT}±10%). While this condition is not met, control signals are generated and transmitted that apply corrective adjustments to the operating states of relevant salt-related BPED control devices. For example, as indicated in block 231-1, control signals are sent to salt recycle valve 146A-21 (shown in FIG. 4) that either increase the salt recycle fraction (i.e., when the measured salt concentration values are less than corresponding initial values) or decrease the salt recycle fraction (i.e., when the measured salt concentration values are greater than corresponding initial values). Because adjustments to the salt recycle fraction can change one or both of the salt inlet pressure and salt outlet pressure, one or both of these pressures is then rechecked (block 232-2), and control passes along the NO branch to block 235-1 when the measured salt pressures (SP) are not substantially equal to their corresponding initial values. In block 235-1, control signals are sent to pressure control pump 145A-21 (shown in FIG. 4) that either increase the salt inlet/outlet pressure (i.e., when the measured salt pressures (SP) are less than corresponding initial values) or decrease the salt inlet/outlet pressure (i.e., when the measured salt pressures (SP) are greater than corresponding initial values). Because a pressure imbalance between the salt, base and acid streams can damage IE stack 135, the inlet/output pressures of both the base solution stream and acid solution stream are then measured and adjusted to levels that are equal to the adjusted salt inlet/outlet pressures (block 236-1). The loop formed by blocks 234-1 to 236-1 is then repeated until the measured salt inlet/outlet pressure SPM is substantially equal to their corresponding initial set-point values (e.g., SIP_{M}=SIP_{INIT}±10%), whereby control passes along the YES branch from block 234-1 back to block 231-1.

Referring to the central column in FIG. 7B, the second phase begins after the salt solution stream has achieved a steady state (YES branch from block 231-1 to block 231-2) and includes controlling the BPED control devices to regulate BPED operations in a manner similar to that described above until measured base-related control parameter values (e.g., BIC_{M}, BOC_{M}, BIP_{M}, BOP_{M} and BFR_{M}) are respectively substantially equal to corresponding initial base-related control parameter set-point values (e.g., BIC_{M}=BIC_{INIT}±10%). That is, base recycle valve 146A-23 (shown in FIG. 4) is adjusted to increase/decrease the base recycle fraction (block 232-2), the base stack pressure is measured (block 233-2, and pressure control valve 145A-23 (shown in FIG. 4) is adjusted to increase/decrease the base (block 232-2) to adjust the base stack pressure (block 235-2) in a manner similar to that utilized to achieve a steady-state for the salt solution stream. Because any base inlet/output pressure adjustment (block 235-2) can create an imbalance, both the salt solution stream and acid solution stream are measured and adjusted to levels that are equal to the adjusted base inlet/outlet pressure (block 236-2). The loop formed by blocks 234-2 to 236-2 is repeated until the measured base inlet/outlet pressures are substantially equal to their corresponding initial set-point values (e.g., BIP_{M}=BIP_{INIT}±10%), whereby control passes along the YES branch from block 234-2 back to block 231-2.

Referring to the right side of FIG. 7B, the third phase of acid/base production ramp-up process 230A begins after both the salt and base solution streams have achieved steady states (YES branch from block 231-2 to block 231-3) and includes controlling the BPED control devices to regulate BPED operations in a manner similar to that described above until measured acid-related control parameter values (e.g., AIC_{M}, AOC_{M}, AIP_{M}, AOP_{M} and AFR_{M}) are respectively substantially equal to corresponding initial acid-related control parameter set-point values (e.g., AIC_{M}=AIC_{INIT}±10%). That is, the operations performed with reference to blocks 232-3 to 236-3 are similar to the operates described above in corresponding blocks 232-1 to 236-1.

Referring again to FIG. 6, acid/base production ramp-up process 230A is completed and control passes to production efficiency optimization process 250A when operational steady-state of BPED 110A is achieved (YES branch from block 240A). Note that “true” steady-state operation of BPED 110A is not achieved by way of start-up procedure 210A because the test for steady-state operation (block 240A) is satisfied when the measured control parameter values are within a specified range (e.g., 5% or 10%) of predetermined set-point values). However, the steady (or pseudo-steady) operational state achieved by way of start-up procedure 210A provides a suitable starting (first) operating state for production efficiency optimization process 250A (i.e., because production efficiency optimization process 250A performs constant updating of the BPED control parameters, it is only necessary for BPED 110A to achieve a sustained level of base/acid production when changes of the control system are minimal). In effect, utilizing production efficiency optimization process 250A reduces the need for a start-up procedure that is capable of achieving true steady-state BPED operations, thereby facilitating optimal production efficiency in a shorter amount of time (i.e., by reducing the time required to perform the start-up procedure).

FIG. 8 depicts a stack current modification process 250A-1 in additional detail according to an embodiment. Stack current modification process 250A-1 is mentioned above as being part of the base production optimization process 250A (see FIG. 6) and implements operations consistent with those described above with reference to production optimization process 250 (FIG. 1). That is, the operations described below are identified with base reference numbers that correspond with related operations described above with reference to FIG. 1, and are distinguished by the suffix designation “A-1”.

Stack current modification process 250A-1 begins by determining a first B/P ratio (production efficiency) value (block 251A-1) when BPED 110A is in a first operating state in the manner described above with reference to block 251 (FIG. 1). The stack current set-point value (e.g., value I_{STACK-SP}, FIG. 5) is then modified (e.g., incrementally changed from the initial set-point value described above with reference to start-up procedure 210A), and the corresponding stack current control signal (e.g., control signal CV_{STACK}, FIG. 4) is updated to reflect the set-point value modification (block 252A-1). Note that the modification involves either an incremental increase or an incremental decrease as described above with reference to operations 252+ and 252− in FIG. 1). As described above with reference to FIG. 4, the updated control signal CV_{STACK} causes AC/DC converter 139A (stack current generator) to modify the current level of stack current I_{STACK} from a first current level (before the update) to a different (second) current level corresponding to the modified stack current set-point value. A second B/P ratio (production efficiency) value is then generated (block 253A-1) when BPED 110A is in the different (second) operating state generated by updating stack current I_{STACK}, where the second B/P ratio is generated in a manner consistent with that described above with reference to blocks 251+ and 251− (FIG. 1). The first and second B/P ratios are then compared (block 254A-1) to determine if the modified stack current set-point value caused an improvement or worsening in the base production efficiency of BPED 110A (block 255A-1) and/or whether a maximum B/P ratio value (production efficiency level) has been reached (block 256A-1). Note that operations 255A-1 and 256A-1 represent simplified depictions of corresponding operations 255+/255− and 256+/256−, respectively, which are described above with reference to FIG. 1 (i.e., the direction of the modification applied to the stack current set-point value during each subsequent iteration of block 252A-1 is determined by the outcome of decision blocks 255A-1 and 256A-1). Stack current modification process 250A-1 is completed with a maximum B/P ratio value is detected (YES branch from block 256A-1).

FIGS. 9A and 9B depict two exemplary uses of stack current modification process 250A-1 to optimize a BPED's base production efficiency. FIG. 9A depicts a first example in which the starting applied stack current level is lower than necessary to achieve optimal production efficiency, and FIG. 9B depicts a second example in which the starting applied stack current level is higher than necessary to achieve optimal production efficiency. These two examples illustrate how systematic stack current modification process 250A-1 is able to detect and correct for Faradaic efficiency drift without predictive knowledge of the underlying independent operating condition variables by biasing the operating state of BPED 110A toward maximum base production efficiency.

FIG. 9A depicts a Faradaic efficiency curve η3 that describes the Faradaic efficiency of IE stack 135A within a period of time in which Faradaic efficiency drift is minimal. At a first time t10 within this period, applied stack current I_{STACK} is at level I10, whereby the production efficiency of BPED 110A is at level PE10. A first pass through stack current modification process 250A-1 (FIG. 8) is then performed, whereby a first B/P value is calculated (block 251A-1), a first stack current modification is applied (block 252A-1), a second B/P value is calculated (block 253A-1) and then a first comparison of the two B/P values is performed (block 254A-1). Note that the direction (i.e., incremental increase or incremental decrease) of the first modification is not important because, if an incremental decrease is applied in the first modification, the result of the first comparison will indicate a decrease (worsening) of production efficiency, thereby causing the next subsequent modification to be opposite in direction (i.e., an incremental increase). Assuming the direction of the first modification is an increase and stack current level I11 is applied at time t11, the corresponding comparison result will indicate an increase (improvement) of production efficiency (i.e., because stack current level I11 produces B/P value PE11, which is greater than production level PE10). During the next loop, the improved production efficiency generated by the first iteration results in the application of a second incremental increase (i.e., from level I11 to level I12) at time t12, and the corresponding comparison result will indicate another increase (improvement) in BPED base production efficiency (i.e., because stack current level I12 produces B/P value PE13, which is greater than production level PE11). During the next subsequent loop, the improved production efficiency generated by the second iteration results in the application of a third incremental increase (i.e., from level I12 to level I13) at time t13. Note that this additional increase generates a decrease (worsening) in the corresponding comparison result (i.e., because stack current level I13 produces B/P value PE12, which is lower than production level PE13). In one embodiment, the change from improvement to worsening of the production efficiency value caused by the third incremental increase is utilized to identify maximum production efficiency value PE12 (corresponding to point η3M) and the applied stack current level is reset to level I12.

FIG. 9B depicts a period of time during which the Faradaic efficiency of IE stack 135A is described by Faradaic efficiency curve η4. At a first time t20 within this period, applied stack current I_{STACK} is at level I23, whereby the production efficiency of BPED 110A is at level PE20. A first pass through stack current modification process 250A-1 is then performed and a first stack current modification is applied (block 252A-1). In this case, if the direction of the first modification is an increase, the result of the first comparison will indicate a decrease (worsening) of production efficiency, thereby causing the next subsequent modification to be opposite in direction (i.e., an incremental decrease). Assuming the direction of the first modification is a decrease and stack current level I22 is applied at time t21, the corresponding comparison result will indicate an increase (improvement) of production efficiency (i.e., because stack current level I22 produces B/P value PE21, which is greater than production level PE20). During the next loop, the improved production efficiency generated by the first iteration results in the application of a second incremental decrease (i.e., from level I22 to level I21) at time t22, and the corresponding comparison result will indicate another increase (improvement) in BPED base production efficiency (i.e., because stack current level I21 produces B/P value PE23, which is greater than production level PE21). During the next subsequent loop, the improved production efficiency generated by the second iteration results in the application of a third incremental decrease (i.e., from level I21 to level I20) at time t23. Note that this additional decrease generates a decrease (worsening) in the corresponding comparison result (i.e., because stack current level I20 produces B/P value PE22, which is lower than production level PE23), facilitating the identification of maximum production efficiency value PE22 (corresponding to point η4M) and the applied stack current level is reset to level I21.

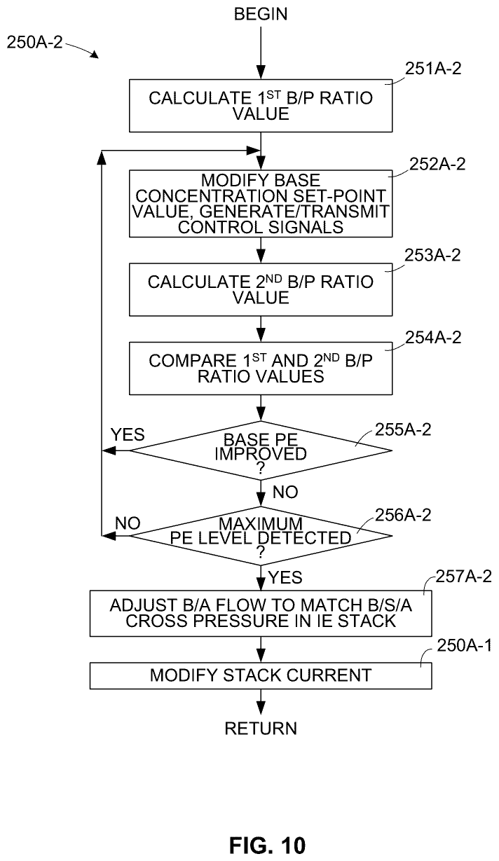

FIG. 10 depicts a base concentration modification process 250A-2 in additional detail according to an embodiment. Changing base concentration (or acid) changes the electrochemical parameters. A larger concentration difference between acid and base will increase V_{OCV}, thus increasing voltage and power. Increasing the concentration difference between base (or acid) and salt will decrease ASR, lowering voltage and power. Increases to voltage will increase shunt currents lowering Faradaic efficiency. Increasing concentrations of any solution will increase shunt currents and decrease Faradaic efficiency. Similar to stack current modification process 250A-1 (described above), base concentration modification process 250A-2 implements operations consistent with production optimization process 250 and identified with base reference numbers distinguished by including the suffix designation “A-2”. A first B/P ratio (production efficiency) value is determined (block 251A-2) when BPED 110A is in a first operating state, and then one or both of the inlet and outlet base concentration set-point values (e.g., values BIC_{SP} and BOC_{SP}, FIG. 5) are modified (incrementally increased or decreased), thereby causing an update to the corresponding base recycle control signal (e.g., control signal C46-23, FIG. 4) to reflect the set-point value modification (block 252A-1), which in turn modifies the base recycle fraction returned to base holding tank 121A-3, thereby producing the desired increase/decrease in base concentration level of (i.e., the amount of base material included in) weak base stream 113A-1). In one embodiment, corresponding modifications are also applied to the salt concentration and acid concentration set-point values that adjust the salt recycle fraction and the acid recycle fraction (e.g., in the manner described above with reference to FIG. 4) to match the base concentration modification. A second B/P ratio value is then generated (block 253A-2), and the first and second B/P ratios are compared (block 254A-2) to determine if the modified base concentration set-point value caused an improvement or worsening in the base production efficiency of BPED 110A (block 255A-2) and/or whether a maximum B/P ratio value (production efficiency level) has been reached (block 256A-2). Referring to the bottom of FIG. 10, after a maximum B/P ratio value is detected (YES branch from block 256A-2), base concentration modification process 250A-2 includes an additional cross-pressure adjustment operation (block 257A-2) in which the base solution stream flow rate, the salt solution stream flow rate and the acid solution stream flow rate (B/S/A FLOW) are adjusted to balance cross-pressure within IE stack 135, and then stack current modification process 250A-1 (described above with reference to FIG. 8) is performed for reasons described below with reference to FIGS. 11A and 11B.

FIGS. 11A and 11B depict an exemplary use of base concentration modification process 250A-2 to optimize a BPED's base production efficiency. FIG. 11A depicts relatively significant changes to the Faradaic efficiency of IE stack 135A that may be achieved by systematic modification of base concentration set-point values. FIG. 11B depicts the use of stack current modification process 250A-1 to further optimize the production efficiency of BPED 110A after a maximum level is achieved by way of the systematic modification of base concentration. This example illustrates how systematically modifying two or more BPED control parameters (i.e., base concentration and stack current) facilitates more accurate base product efficiency optimization than systematically modifying a single BPED control parameter.

FIG. 11A depicts a series of Faradaic efficiency curves η50 to η53 to illustrate the relatively significant changes in Faradaic efficiency that may be achieved by the systematic modifications of one or both of the inlet and outlet base concentration set-point values (e.g., values BIC_{SP} and BOC_{SP}, FIG. 5). Faradaic efficiency curves η50 to η53 describe the Faradaic efficiency of IE stack 135A at different times t30 to t33, respectively, with Faradaic efficiency curves η50 representing an initial Faradaic efficiency occurring at time t30. In this example, stack current modification process 250A-1 was implemented prior to time t30 to maximize production efficiency of BPED 110A while IE stack 135A was operating with Faradaic efficiency η50, whereby stack current I_{STACK} has a level I31 at time t30 in order to achieve base production efficiency level PE30, which corresponds to value PE30 (corresponding to maximum production efficiency point η50M of Faradaic efficiency η50).

A first pass through the loop portion of base concentration modification process 250A-2 (FIG. 10) is performed between time t0 and t1, whereby a first B/P value is calculated (block 251A-2), a first base concentration set-point modification is applied (block 252A-2), a second B/P value is calculated (block 253A-2) and then a first comparison of the two B/P values is performed (block 254A-2). In this example the first modification changes the operating state of BPED 110A such that production efficiency increases from PE30 to PE31 (i.e., as indicated by point η510). Note that the applied base concentration set-point modification also changes the Faradaic efficiency of IE stack 135A in a more significant manner (i.e., in comparison to an incremental stack current modification), and this more significant change is depicted by way of Faradaic efficiency line η51 (i.e., the BPED operating state change caused by the first base concentration set-point modification causes the Faradaic efficiency of IE stack 135A to effectively shift upward from Faradaic efficiency line η50 at time t0 to Faradaic efficiency line η51, as indicated by arrow A51 at time t1). For reasons similar to those described above with reference to stack current modification process 250A-1, the direction (i.e., incremental increase or incremental decrease) of the first base concentration set-point modification is not important because, if an incremental change indicates a decrease (worsening) in production efficiency, the next subsequently applied modification would be opposite in direction. Note also that all other BPED control parameters are maintained (unchanged) during the loop phase of the base concentration modification process 250A-2 (e.g., stack current is maintained at level I31).

Additional passes through the loop portion of base concentration modification process 250A-2 are then performed until a maximum production efficiency level is detected. In the depicted example, a second base concentration set-point modification increases production efficiency from PE31 to PE32 (i.e., as indicated by point η520), and effectively shifts the Faradaic efficiency of IE stack 135A upward from Faradaic efficiency line η51 at time t1 to Faradaic efficiency line η52 at time t2, as indicated by arrow A52). A third base concentration set-point modification then increases production efficiency from PE32 to PE33 (i.e., as indicated by point η530), and effectively shifts the Faradaic efficiency of IE stack 135A upward from Faradaic efficiency line η52 at time t2 to Faradaic efficiency line η53 at time t3, as indicated by arrow A53). For purposes of this example, it is assumed that subsequent passes through the loop portion of base concentration modification process 250A-2 fail to achieve a further increase in base production efficiency, and that base production efficiency level PE33 is identified as a detected maximum production efficiency level (i.e., referring to FIG. 10, control passes from block 256A-2 along the YES branch to block 257A-2).

FIG. 11B illustrates the use of stack current modification process 250A-1 to further optimize base production efficiency after completing the loop portion of base concentration modification process 250A-2. That is, at time t33 the Faradaic efficiency of IE stack 135A is indicated by Faradaic efficiency line η53 and applied stack current I_{STACK} is maintained at current level I31. Note that the high point of Faradaic efficiency line η53 (corresponding to point η53M) occurs at maximum production efficiency value PE34 and is achieved using a stack current level I30. Stack current modification process 250A-1 is utilized in a manner similar to that described above with reference to FIG. 9B to systematically decrease stack current I_{STACK} from current level I31 at time t33 to current level I30 at time t34, thereby increasing production efficiency from level PE33 to maximum production efficiency value PE34 (i.e., as indicated by arrow A6). For illustrative purposes, it is assumed that neither Faradaic efficiency drift nor the flow/pressure adjustments performed in block 257A-2 significantly change the Faradaic efficiency of IE stack 135A between times t34 and t35.

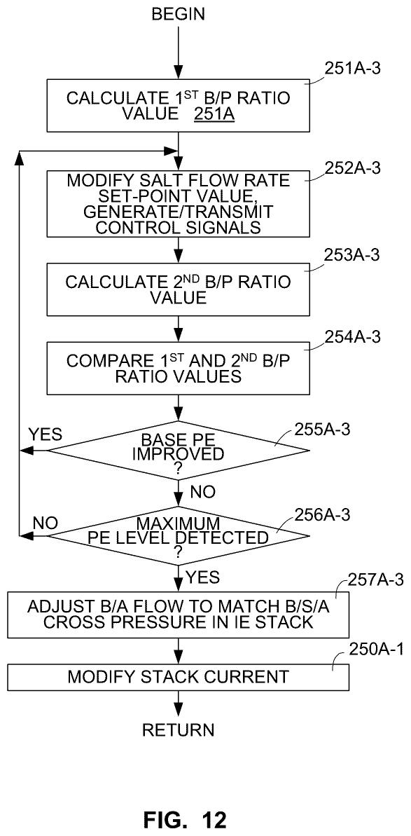

FIG. 12 depicts a salt flow rate modification process 250A-3 in additional detail according to an embodiment. Increasing salt flow rate increases the amount of salt available for conversion, which decreases mass transport limitations to reaction (i.e., lowering ASR and stack voltage/power). Increasing salt flow also increases pressure drop across the IE stack, which in turn causes acid and base flow to increase to compensate cross pressure. This increased flow uses more pump power and changes the outlet concentration of acid/base. Similar to stack current modification process 250A-1 and base concentration modification process 250A-2 (described above), salt flow rate modification process 250A-3 implements operations consistent with production optimization process 250 and identified with base reference numbers distinguished by including the suffix designation “A-3”. A first B/P ratio (production efficiency) value is determined (block 251A-3) when BPED 110A is in a first operating state, and then the salt flow rate set-point value (e.g., value SFR_{SP}, FIG. 5) is modified (incrementally increased or decreased), thereby causing an update to the corresponding salt flow rate control signal (e.g., control signal C45-21, FIG. 4) to reflect the set-point value modification (block 252A-2), which in turn causes pressure control valve 145A-21 to produce the desired increase/decrease in the flow rate of strong salt stream 111A-1 from salt holding tank 121A-1 to IE stack 135A. A second B/P ratio value is then generated (block 253A-3), and the first and second B/P ratios are compared (block 254A-3) to determine if the modified salt flow rate set-point value caused an improvement or worsening in the base production efficiency of BPED 110A (block 255A-3) and/or whether a maximum B/P ratio value has been reached (block 256A-3). After a maximum B/P ratio value is detected (YES branch from block 256A-3), a cross-pressure adjustment operation (block 257A-3) in which the base solution stream flow rate and the acid solution stream flow rate (B/A FLOW) are adjusted to balance cross-pressure within IE stack 135, and then stack current modification process 250A-1 is repeated for reasons similar to those described above with reference to FIGS. 11A and 11B (i.e., salt flow rate modification process 250A-3 has a similar effect on Faradaic efficiency as that described above with reference to base concentration modification process 250A-2).

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A computer-implemented method for operating a bipolar electrodialysis device (BPED), the BPED including an ion exchange (IE) stack having a plurality of flow channels respectively separated by ion exchange membranes that are cooperatively configured to electrochemically process salt disposed in a salt solution stream to produce both an acid substance in an acid solution stream and a base substance in a base solution stream, wherein an operating state of the BPED is controlled by a plurality of BPED control parameters, and wherein a BPED production efficiency is determined by a rate of production of one of said base substance and said acid substance and a corresponding amount of consumed electrical power, the method comprising:
generating a first production efficiency value while the BPED is in a first operating state;
applying a first modification in a first direction to a first BPED control parameter such that the BPED changes from the first operating state to a second operating state;
generating a second production efficiency value while the BPED is in the second operating state; and
comparing the first and second production efficiency values; and
applying a second modification to the first BPED control parameter such that a second direction of the second modification is equal to the first direction when said comparison of the first and second production efficiency values indicates that applying the first modification caused the BPED production efficiency to increase, and such that the second direction of the second modification is opposite to the first direction when said comparison indicates that applying the first modification caused the BPED production efficiency to decrease.

2. The method of claim 1, wherein generating the first production efficiency value comprises:
measuring a first concentration of said base substance in a portion of the base solution stream located upstream of the IE stack, measuring a second concentration of said base substance in a portion of the base solution stream located downstream of the IE stack, measuring a base flow rate of the base solution stream passing through the IE stack, and then multiplying the base flow rate times a difference between the first and second base concentrations to calculate a first substance production rate,
determining a rate of power consumption while the BPED is in a first operating state,
dividing the first substance production rate by a corresponding rate of power consumed by the OAE system while the BPED is in a first operating state.

3. The method of claim 1, wherein generating the first production efficiency value comprises:
measuring a first concentration of said acid substance in a portion of the acid solution stream located upstream of the IE stack, measuring a second concentration of said acid substance in a portion of the acid solution stream located downstream of the IE stack, measuring an acid flow rate of the acid solution stream passing through the IE stack, and then multiplying the acid flow rate times a difference between the first and second acid concentrations to calculate a first substance production rate,
determining a rate of power consumption while the BPED is in a first operating state,
dividing the first substance production rate by a corresponding rate of power consumed by the OAE system while the BPED is in a first operating state.

4. The method of claim 1,
wherein applying the first modification in the first direction comprises incrementally increasing the BPED control parameter,
wherein applying the second modification in the second direction comprises incrementally increasing the BPED control parameter when the second production efficiency value is greater than the first production efficiency value, and
wherein applying the second modification in the second direction comprises incrementally decreasing the BPED control parameter when the first production efficiency value is greater than the second production efficiency value.

5. The method of claim 4, wherein incrementally increasing the first control parameter comprises increasing a set-point value of the first control parameter by an incremental amount in the range of 1% to 10%.

6. The method of claim 1,
wherein applying the first modification in the first direction comprises incrementally decreasing the BPED control parameter,
wherein applying the second modification in the second direction comprises incrementally decreasing the BPED control parameter when the second production efficiency value is greater than the first production efficiency value, and
wherein applying the second modification in the second direction comprises incrementally increasing the BPED control parameter when the first production efficiency value is greater than the second production efficiency value.

7. The method of claim 1, wherein applying the first modification to the first control parameter comprises incrementally changing one of:
a stack current applied through the IE stack;
a concentration of one of the salt in the salt solution stream, the acid substance in the acid solution stream and the base substance in the base solution stream; and
a flow rate through the IE stack of one of the salt solution stream, the acid solution stream and the base solution stream.

8. The method of claim 7,
wherein incrementally changing said stack current comprises:
modifying a stack current set-point value from a first stack current value to a second stack current value,
updating a stack current control signal from a first current signal value corresponding to the first stack current value to a second current signal value corresponding to the second stack current value; and
wherein the BPED comprises a stack current generator configured to generate said stack current in accordance with the stack current control signal such that the stack current generator generates said stack current at a first current level corresponding to the first stack current value before the stack current control signal is updated, and the stack current generator generates said stack current at a second current level corresponding to the second stack current value after said updating.

9. The method of claim 7,
wherein incrementally changing the concentration of the base substance in the base solution stream comprises:
modifying a base concentration set-point value from a first concentration value to a second concentration value,
updating a recycle fraction control signal from a first recycle signal value corresponding to the first concentration value to a second recycle signal value corresponding to the second concentration value; and
wherein the BPED comprises:
a base holding tank configured to store a quantity of base solution and to supply the base solution stream to the IE stack, and
a base recycle valve configured to divide the base solution stream exiting the IE stack in accordance with the recycle fraction control signal such that a base recycle fraction directed back to the base holding tank comprises a first fractional value of the base solution stream corresponding to the first concentration value before the recycle fraction control signal is updated, and comprises a second fractional value of the base solution stream corresponding to the second concentration value after the recycle fraction control signal is updated.

10. The method of claim 7,
wherein incrementally changing the flow rate of the salt solution stream comprises:
modifying a salt flow rate set-point value from a first flow rate value to a second flow rate value,
updating a pump control signal from a first pump signal value corresponding to the first flow rate value to a second pump signal value corresponding to the second flow rate value; and
wherein the BPED comprises:
a salt holding tank configured to store a quantity of salt solution, and
a pressure control pump configured to supply the salt solution stream from the salt holding tank to the IE stack in accordance with the pump control signal such that the salt solution stream comprises a first flow rate corresponding to the first flow rate value before the pump control signal is updated, and comprises a second flow rate corresponding to the second flow rate value after the pump control signal is updated.

11. The method of claim 1, wherein the method further comprises applying a third modification to a second BPED control parameter when said comparing indicates that a maximum BPED production efficiency level was achieved by applying the first modification.

12. The method of claim 11,
wherein the first control parameter comprises a stack current parameter defining an amount of electrical current applied across the IE stack to facilitate the electrochemical process; and
wherein the second control parameter comprises one of:
a base concentration parameter defining a concentration of said base substance in the base solution stream supplied to the IE stack during the electrochemical process, and
a salt flow rate parameter of the salt solution stream supplied to the IE stack during the electrochemical process.

13. The method of claim 11,
wherein the first control parameter comprises a stack current parameter defining an amount of electrical current applied across the IE stack to facilitate the electrochemical process; and
wherein the second control parameter comprises one of:
an acid concentration parameter defining a concentration of said acid substance in the acid solution stream supplied to the IE stack during the electrochemical process, and
a salt flow rate parameter of the salt solution stream supplied to the IE stack during the electrochemical process.

14. The method of claim 1, further comprising:
systematically modifying said first control parameter by repeating said modifying, said generating and said comparing during a first time period that ends when said comparing indicates that the BPED production efficiency achieves a first maximum level;
systematically modifying a second said control parameter during a second period starting after the BPED production efficiency achieves the first maximum level and until the BPED production efficiency achieves a second maximum level; and
systematically modifying a third said control parameter during a third period starting after the BPED production efficiency achieves the second maximum level and until the BPED production efficiency achieves a third maximum level.

15. The method of claim 14, wherein systematically modifying each of the second and third control parameters comprises:
determining a third production efficiency level of the BPED when the BPED is a third operating state;
modifying said each second and third control parameter in a second direction such that the BPED changes from the third operating state to a fourth operating state, where modifying in the second direction includes one of incrementally increasing and incrementally decreasing [i.e., either increasing or decreasing] said each second and third control parameter;
determining a fourth production efficiency level of the BPED when the BPED is the fourth operating state;
comparing the third and fourth production efficiency levels; and
until the BPED achieves one of the second maximum production efficiency level and the third maximum production efficiency level, modifying said each second and third control parameter in the second direction when the fourth production efficiency level is greater than the third production efficiency level, and modifying said each second and third control parameter in a direction opposite to the second direction when the third production efficiency level is greater than the fourth production efficiency level.

16. The method of claim 14, further comprising repeating said systematically modifying of said first, second and third control parameters after the third time period.

17. The method of claim 1, further comprising:
performing an initial start-up process including ramping up a stack current applied through the IE stack until the applied stack current is substantially equal to a predetermined initial stack current set-point value; and
using a plurality of initial control parameter set-point values to control a plurality of BPED control devices of said BPED until the BPED achieves the first operating state in which a plurality of measured control parameter values are substantially equal to a plurality of initial control parameter set-point values,
wherein generating said first production efficiency value is performed after the BPED achieves the first operating state.

18. A computer-implemented method for operating a bipolar electrodialysis device (BPED), the BPED including an ion exchange (IE) stack having a plurality of flow channels respectively separated by ion exchange membranes that are cooperatively configured to electrochemically process salt disposed in a salt solution stream to produce both an acid substance in an acid solution stream and a base substance in a base solution stream, wherein an operating state of the BPED is controlled by a plurality of BPED control parameters, and wherein a production efficiency of the BPED is determined by a rate of production of one of said base substance and said acid substance and a corresponding amount of consumed electrical power, the method comprising:
systematically modifying a first said control parameter during a first time period that ends when the BPED production efficiency achieves a first maximum level; and
systematically modifying a second said control parameter during a second period starting after the BPED production efficiency achieves the first maximum level and ending when the BPED production efficiency achieves a second maximum level.

19. The method of claim 18, wherein systematically modifying each of the first and second control parameters comprises:
determining a first production efficiency level of the BPED when the BPED is a first operating state;
modifying said each first and second control parameter in a first direction such that the BPED changes from the first operating state to a second operating state, where modifying in the first direction includes one of incrementally increasing and incrementally decreasing said each first and second control parameter;
determining a second production efficiency level of the BPED when the BPED is the second operating state;
comparing the first and second production efficiency levels; and
until the BPED achieves one of the first and second maximum production efficiency levels, modifying said each second and third control parameter in the first direction when the second production efficiency level is greater than the first production efficiency level, and modifying said each second and third control parameter in a direction opposite to the first direction when the first production efficiency level is greater than the second production efficiency level.

20. An electrochemical ocean alkalinity enhancement (OAE) system configured to capture atmospheric carbon dioxide and mitigate ocean acidification, the OAE system comprising:
a BPED including an ion exchange (IE) stack having a plurality of flow channels respectively separated by ion exchange membranes that are cooperatively configured to electrochemically process salt disposed in a salt solution stream to produce both an acid substance in an acid solution stream and a base substance in a base solution stream, wherein an operating state of the BPED is controlled by a plurality of BPED control parameters, and wherein a production efficiency of the BPED is determined by a rate of production of one of said base substance and said acid substance and a corresponding amount of consumed electrical power; and
a control circuit configured to control operations performed by the BPED such that:
a first production efficiency value is generated while the BPED is in a first operating state;
a first modification is applied to a first BPEDcontrol parameter such that the BPED changes from the first operating state to a second operating state;
a second production efficiency value is generated while the BPED is in the second operating state; and
a second modification to the first BPEDcontrol parameter is applied when the second production efficiency value is different from the first production efficiency value,
wherein the second modification is equal to the first modification when the second production efficiency value is greater than the first production efficiency value, and
wherein the second modification is opposite to the first modification when the first production efficiency value is greater than the second production efficiency value.
